(19) United States
(12) Patent Application Publication
(10) Pub. No.: US 2016/0338120 A1
(43) Pub. Date: Nov. 17, 2016

(54) System And Method Of Communicating Between Interactive Systems

(71) Applicant: SMART Technologies, ULC, Calgary (CA)

(72) Inventor: Michael BOYLE, Calgary (CA)

(21) Appl. No.: 14/712,452

(22) Filed: May 14, 2015

(51) Int. Cl. H04W 76/02; H04W 12/06; H04L 29/06; H04N 5/225; G06T 3/40

(52) U.S. Cl. CPC H04W 76/023; H04N 5/225; G06T 3/40; H04L 65/403; H04W 12/06

(57) ABSTRACT

The present invention relates to a method and system for adapting communication between interactive input systems. A mobile device has a processing structure; a transceiver communicating with a network using a communication protocol; and a computer-readable medium comprising instructions to configure the processing structure. The mobile device is configured to retrieve a pairing uniform resource locator (URL) from an interactive device and convert the pairing URL into a network address. A connection is established to an interactive device located at the network address using the transceiver. The mobile device queries the interactive device for device information and authenticates with the interactive device. One or more content objects are retrieved from the interactive device. The mobile device optimizes the communication protocol through negotiation of a protocol level based in part on the device information.

### FIELD OF THE INVENTION

The present invention relates generally to communication between interactive input systems. More particularly, the present invention relates to a method and system for adapting communication between interactive input systems.

### BACKGROUND OF THE INVENTION

With the increased popularity of distributed computing environments and smart phones, it is becoming increasingly unnecessary to carry multiple devices. A single device can provide access to all of a user's information, content, and software. Software platforms can now be provided as a service remotely through the Internet. User data and profiles are now stored in the “cloud” using services such as Facebook®, Google Cloud storage, Dropbox®, Microsoft OneDrive®, or other services known in the art. One problem encountered with smart phone technology is that users frequently do not want to work primarily on their smart phone due to their relatively small screen size and/or user interface.

Conferencing systems that allow participants to collaborate from different locations, such as for example, SMART Bridgit™, Microsoft® Live Meeting, Microsoft® Lync, Skype™, Cisco® MeetingPlace, Cisco® WebEx, etc., are well known. These conferencing systems allow meeting participants to exchange voice, audio, video, computer display screen images and/or files. Some conferencing systems also provide tools to allow participants to collaborate on the same topic by sharing content, such as for example, display screen images or files amongst participants. In some cases, annotation tools are provided that allow participants to modify shared display screen images and then distribute the modified display screen images to other participants.

Prior methods for connecting smart phones, with somewhat limited user interfaces, to conferencing systems or more suitable interactive input devices such as interactive whiteboards, displays such as high-definition televisions (HDTVs), projectors, conventional keyboards, etc. have been unable to provide a seamless experience for users. In addition, the prior methods have difficulty adapting communication protocols to meet different mobile device requirements.

For example, SMART Bridgit™ offered by SMART Technologies ULC of Calgary, Alberta, Canada, assignee of the subject application, allows a user to set up a conference having an assigned conference name and password at a server. Conference participants at different locations may join the conference by providing the correct conference name and password to the server. During the conference, voice and video connections are established between participants via the server. A participant may share one or more computer display screen images so that the display screen images are distributed to all participants. Pen tools and an eraser tool can be used to annotate on shared display screen images, e.g., inject ink annotation onto shared display screen images or erase one or more segments of ink from shared display screen images. The annotations made on the shared display screen images are then distributed to all participants.

U.S. Publication No. 2012/0144283 to SMART Technologies ULC, assignee of the subject application, the entire disclosure of which is incorporated by reference, discloses a conferencing system having a plurality of computing devices communicating over a network during a conference session. The computing devices are configured to share content displayed with other computing devices. Each computing device in the conference session supports two input modes namely, an annotation mode and a cursor mode depending on the status of the input devices connected thereto. When a computing device is in the annotation mode, the annotation engine overlies the display screen image with a transparent annotation layer to annotate digital ink over the display. When cursor mode is activated, an input device may be used to select digital objects or control the execution of application programs.

U.S. Pat. No. 8,862,731 to SMART Technologies ULC, assignee of the subject application, the entire disclosure of which is incorporated by reference, presents an apparatus for coordinating data sharing in a computer network. Participant devices connect using a unique temporary session connect code to establish bidirectional communication session for sharing data on a designated physical display device. Touch data received from the display is then transmitted to all of the session participant devices. Once the session is terminated, a new unique temporary session code is generated.

U.S. Publication No. 2011/0087973 to SMART Technologies ULC, assignee of the subject application, the entire disclosure of which is incorporated by reference, discloses a meeting appliance running a thin client rich internet application configured to communicate with a meeting cloud, and access online files, documents, and collaborations within the meeting cloud. When a user signs into the meeting appliance using network credentials or a sensor agent such as a radio frequency identification (RFID) agent, an adaptive agent adapts the state of an interactive whiteboard to correspond to the detected user. The adaptive agent queries a semantic collaboration server to determine the user's position or department within the organization and then serves applications suitable for the user's position. The user, given suitable permissions, can override the assigned applications associated with the user's profile.

The invention described herein provides a seamless connection experience and provides an improved system and method of communicating between mobile devices and interactive systems.

### SUMMARY OF THE INVENTION

According to one aspect of the invention, there is provided a mobile device having a processing structure; a transceiver communicating with a network using a communication protocol; and a computer-readable medium comprising instructions to configure the processing structure to: retrieve a pairing uniform resource locator (URL) from an interactive device; convert the pairing URL into a network address; establish a connection to an interactive device located at the network address using the transceiver; query for device information of the interactive device over the connection; authenticate the mobile device with the interactive device; and retrieve at least one content object from the interactive device. The processing structure may initiate an optimization of the communication protocol by negotiation of a protocol level based in part on the device information. Each protocol level may have a different set of protocol rules.

In yet another aspect of the invention, there is provided a method of establishing a connection between a mobile device and an interactive device. A pairing uniform resource locator (URL) may be retrieved from the interactive device and may be converted into a network address using a processing structure. The connection is established to the interactive device located at the network address using a transceiver. Device information may be queried from the interactive device over the connection. The mobile device may be authenticated with the interactive device and may receive one or more content objects from the interactive device. The method may further initiate an optimization of the communication protocol by negotiating a protocol level based in part on the device information. A set of protocol rules may be altered based on the protocol level.

In another aspect of the invention, there is provided an interactive device comprising: a processing structure; an interactive surface; a transceiver communicating with a network using a communication protocol; and a computer-readable medium comprising instructions to configure the processing structure to: provide a service to receive connections from a mobile device; respond to a query for device information over the connection; authenticate the mobile device with the interactive device; and transmit at least one content object over the connection to the mobile device. The interactive device further may have instructions to configure the processor to optimize the communication protocol by negotiating a protocol level whereby each protocol level comprises a different set of protocol rules.

One of the protocol rules mentioned in any aspect of the invention may synchronize the timer with a reference clock; the timer stored within the memory and serviced by the processing structure. The processing structure may determine a stratum level by measuring the network distance of the mobile device to a time server and report the stratum level to other devices on the network using the transceiver. The processing structure may select the lowest received stratum as the reference clock. The time base of the timer may also be negotiated.

Another of the protocol rules mentioned in any aspect of the invention may adjust a resolution of a coordinate space wherein the resolution may be absolute coordinate resolution, relative coordinate resolution, or both absolute and relative coordinate resolution. The coordinate space may correspond to a canvas size comprising a diagonal of less than about 7.5191 m for a 16:9 aspect ratio. The absolute coordinate resolution may be between about 0.005 mm/bit and about 0.1 mm/bit and the relative coordinate resolution may be between about 0.005 mm/bit and about 0.1 mm/bit.

The content object according to any aspect mentioned in any aspect of the invention may be at least one of digital ink object, a shape object, a curve object, a vector object, an audio object, an image object, a text object, or a video object whereby one of the protocol rules may adjust at least one digital ink attribute of the digital ink object. The digital ink object may have an attribute such as pointer resolution of 0.5 mm/bit, stroke colour, and/or a set of unique pointer identifiers. Each of the content objects may have a unique content object identifier and may also have a creation timestamp retrieved from a timer. Another aspect of the invention may comprise configuring the processing structure to display each content object at a relative time according to the creation timestamp. In another aspect of the invention, remote content objects may be received by the mobile device from remote interactive devices.

The mobile device in any aspect mentioned may have a computer-readable medium that may comprise a unique identifier for the mobile device whereby one of the protocol rules comprises negotiating an alias for the unique identifier.

The interactive device mentioned may be one or more of a capture board, an interactive whiteboard, an interactive flat screen display, or an interactive table.

According to any aspect of the invention, an image sensor may capture an optically recognizable image and may decode the optically recognizable image to retrieve the pairing uniform resource locator. Alternatively, a near field radio frequency reader may receive the pairing uniform resource locator.

### BRIEF DESCRIPTION OF THE DRAWINGS

An embodiment will now be described, by way of example only, with reference to the attached Figures, wherein:

FIG. 1 shows an overview of collaborative devices in communication with one or more portable devices and servers;

FIGS. 2A and 2B show a perspective view of a capture board and control icons respectively;

FIGS. 3A to 3C demonstrate a processing architecture of the capture board;

FIG. 4A to 4D show a touch detection system of the capture board;

FIG. 5 demonstrates a processing structure of a mobile device;

FIG. 6 shows a processing structure of one of more servers;

FIGS. 7A and 7B demonstrate an overview of processing structure and protocol stack of a communication system;

FIGS. 8A and 8B show a flowchart of a mobile device configured to execute a dedicated application thereon;

FIG. 9 shows a flowchart for generating a capture board identifier;

FIGS. 10A to 10C show a flowchart of a capture board configured to optimize communication with the mobile devices; and

FIG. 11 demonstrates a flowchart for closing a communication session.

### DETAILED DESCRIPTION OF THE EMBODIMENT

While the Background of Invention described above has identified particular problems known in the art, the present invention provides, in part, a new and useful application adapting communication between interactive systems.

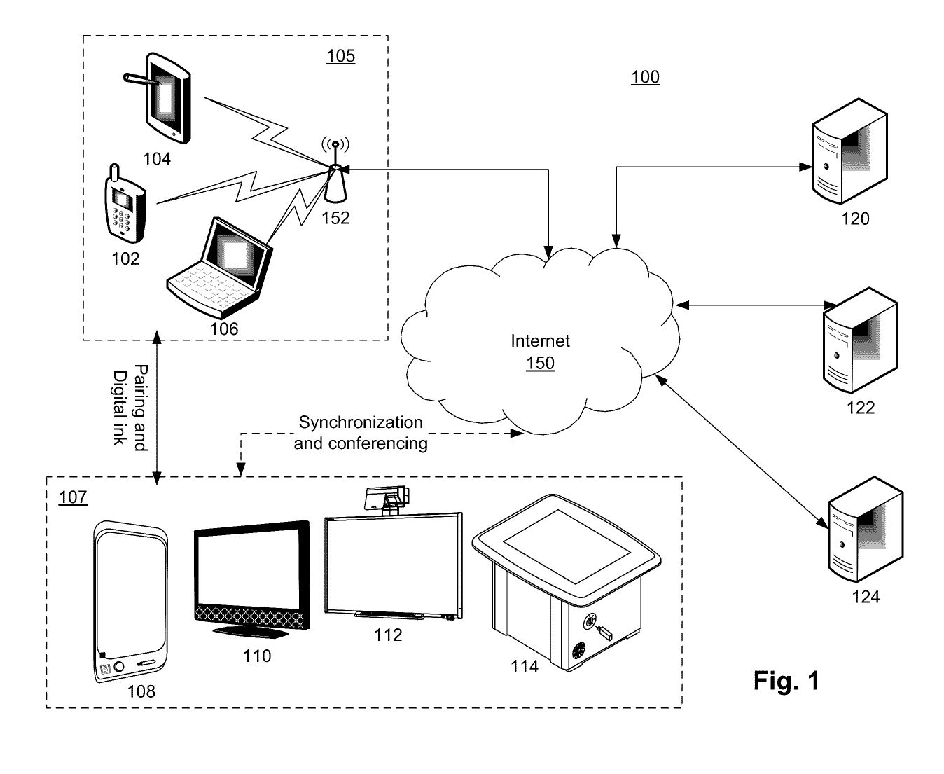

FIG. 1 demonstrates a high-level hardware architecture 100 of the present embodiment. A user has a mobile device 105 such as a smartphone 102, a tablet computer 104, or laptop 106 that is in communication with a wireless access point 152 such as 3G, LTE, WiFi, Bluetooth®, near-field communication (NFC) or other proprietary or non-proprietary wireless communication channels known in the art. The wireless access point 152 allows the mobile devices 105 to communicate with other computing devices over the Internet 150. In addition to the mobile devices 105, a plurality of collaborative devices 107 such as a Kapp™ capture board 108 produced by SMART Technologies, wherein the User's Guide is herein incorporated by reference, an interactive flat screen display 110, an interactive whiteboard 112, or an interactive table 114 may also connected to the Internet 150. The system comprises an authentication server 120, a profile or session server 122, and a content server 124. The authentication server 120 verifies a user login and password or other type of login such as using encryption keys, one time passwords, etc. The profile server 122 saves information about the user logged into the system. The content server 124 comprises three levels: a persistent back-end database, middleware for logic and synchronization, and a web application server. The mobile devices 105 may be paired with the capture board 108 as will be described in more detail below. The capture board 108 may also provide synchronization and conferencing capabilities over the Internet 150 as will also be further described below.

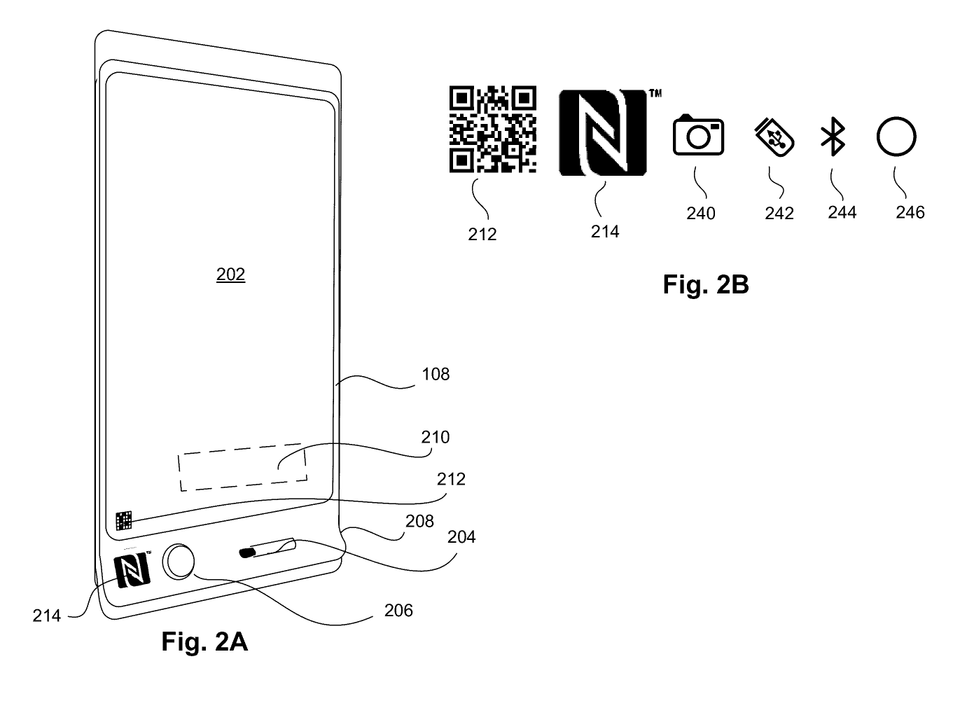

As shown in FIG. 2A, the capture board 108 comprises a generally rectangular touch area 202 whereupon a user may draw using a dry erase marker or pointer 204 and erase using an eraser 206. The capture board 108 may be in a portrait or landscape configuration and may be a variety of aspect ratios. The capture board 108 may be mounted to a vertical support surface such as for example, a wall surface or the like or optionally mounted to a moveable or stationary stand. Optionally, the touch area 202 may also have a display 318 for presenting information digitally and the marker 204 and eraser 206 produces virtual ink on the display 318. The touch area 202 comprises a touch sensing technology capable of determining and recording the pointer 204 (or eraser 206) position within the touch area 202. The recording of the path of the pointer 204 (or eraser) permits the capture board to have an digital representation of all annotations stored in memory as described in more detail below.

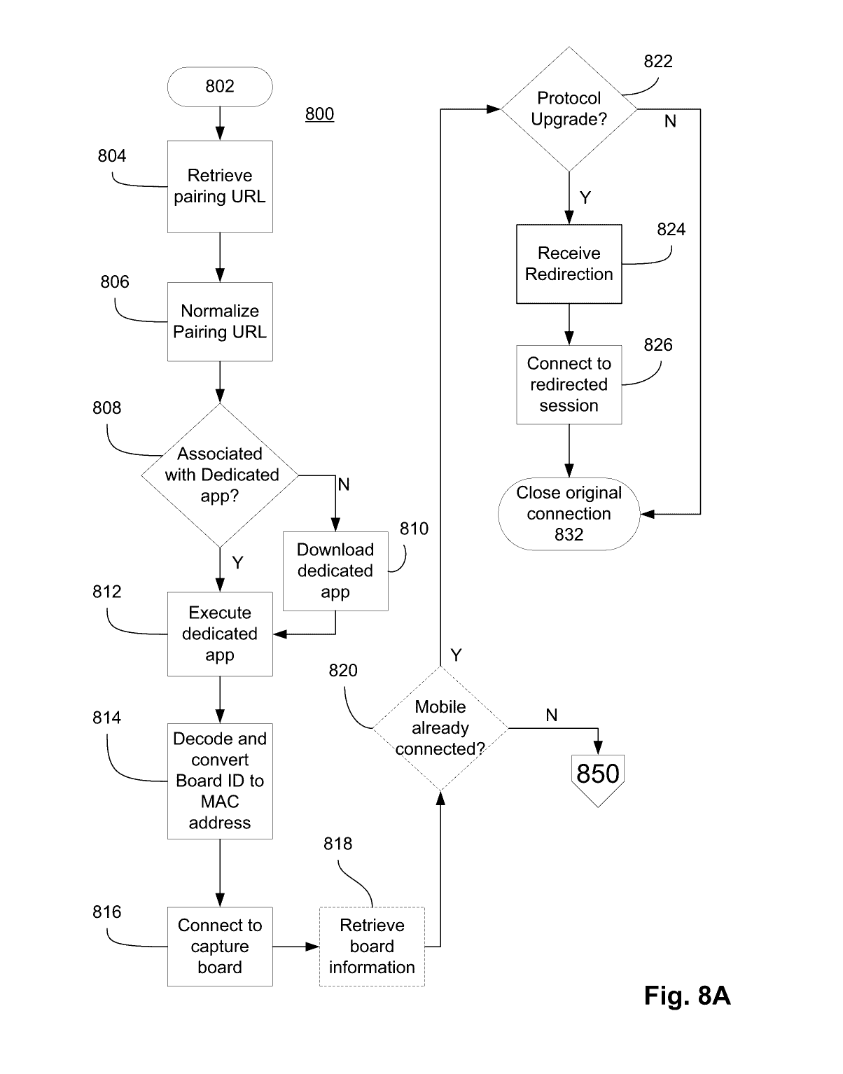

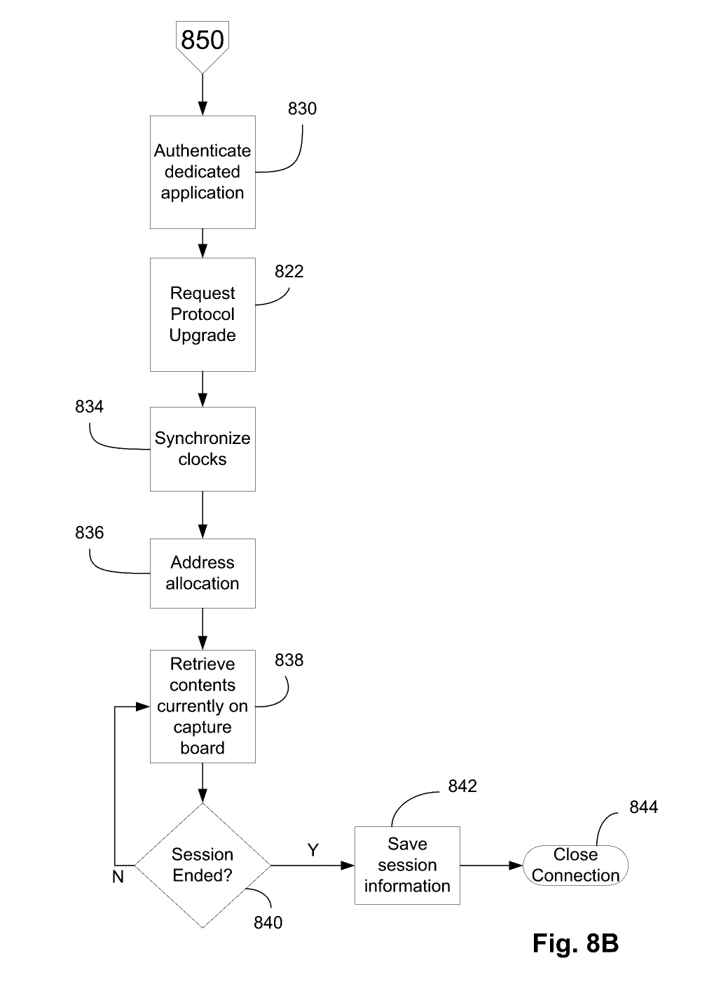

The capture board 108 comprises at least one of a quick response (QR) code 212 and/or a near-field communication (NFC) area 214 of which may be used to pair the mobile device 105 to the capture board 108. The QR code 212 is a two-dimensional bar code that may be uniquely associated with the capture board 108. In this embodiment, the QR Code 212 comprises a pairing Universal Resource Locator (URL) derived from the Bluetooth address of the board as described below with reference to FIGS. 8A and 8B. For example, the Bluetooth address D8:A2:5E:88:9D:BB may be encoded to the 10-character portion “uvumh2tb36”, which is referred to herein as the board ID. To construct a complete pairing URL with a board ID, the board ID is prefixed with “https://kappboard.com/board/” or other suitable web address prefix. Alternatively, the web address and board ID may be presented on the capture board 108 in plain text permitting the user to enter it manually in a web browser or an application executing on the mobile device 105.

The pairing URL may be encoded as an ISO/IEC 180004 compatible QR Code 212. To construct the QR code 212, the 38-character pairing URL may be encoded to ISO 8859-1. These encoded bytes may be formatted as a QR code 212 using the binary input data type with M level of error correction using a Version 3 (29×29 module) Model 2 code. The QR code 212 may be presented with 4-module whitespace margin on all four sides. When printed, each module may be at least 1 mm×1 mm to allow for easy scanning at arm's length distances (approximately 3 ft). At this module size, the total area of the printed QR code 212 (including its recommended whitespace margin) is approximately 37 mm².

The NFC area 214 comprises a loop antenna (not shown) that interfaces by electromagnetic induction to a second loop antenna 340 located within the mobile device 105. Near-field communication operates within the globally available and unlicensed radio frequency ISM band of 13.56 MHz on ISO/IEC 18000-3 air interface and at rates ranging from 106 kbit/s to 424 kbit/s. In the present embodiment, the NFC area 214 acts as a passive target for the initiator within the mobile device 105. The initiator actively generates an RF field that can power the passive target. This enables NFC targets 214 to be simple form factors such as tags, stickers, key fobs, or battery-less cards, which are inexpensive to produce and easily replaceable. NFC tags 214 contain data (currently between 96 and 4,096 bytes of memory) and are typically read-only, but may be rewritable. In alternative embodiments, NFC peer-to-peer communication is possible, such as placing the mobile device 105 in a cradle. In this alternative, the mobile device 105 is preferably powered.

Similar as for the QR code 212, the NFC tag 214 stores the pairing URL produced in a similar manner as for the QR code 212. For the NFC tag 214 embodiment, the pairing URL may be encoded onto NFC Forum Type 2-compliant NFC tags with a minimum of 64 bytes of memory total (48 bytes of data memory). The tag 214 should encode a single NFC Data Exchange Format (NDEF) record giving the pairing URL using the URI data type. After initial formatting and programming, the tag 214 may be locked to prevent end-user rewrite. Below is the general structure of the NDEF record encoded on the tag 214. The board ID portion of the pairing URL is represented by the board ID “uvumh2tb36” in the example.

FLAGS=0xD1 (MB=1,ME=1,CF=0,SR=1,IL=0,TNF=0x01 RTD) [1 byte]
TYPE_LENGTH=1 [1 byte]
PAYLOAD_LENGTH=31 [1 byte]
TYPE=0x55 (‘U’) [1 byte]
PAYLOAD: [31 bytes]
Identifier code=0x04 (https://) [1 byte]
URI=kappboard.com/board/uvumh2tb36 [39 bytes]

As shown in FIG. 2B, an elongate icon control bar 210 may be present adjacent the bottom of the touch area 202 or on the tool tray 208 and this icon control bar may also incorporate the QR code 212 and/or the NFC area 214. All or a portion of the control icons within the icon control bar 210 may be selectively illuminated (in one or more colours) or otherwise highlighted when activated by user interaction or system state. Alternatively, all or a portion of the icons may be completely hidden from view until placed in an active state. The icon control bar 210 may comprise a capture icon 240, a universal serial bus (USB) device connection icon 242, a Bluetooth/WiFi icon 244, and a system status icon 246 as will be further described below. Alternatively, if the capture board 108 has a display 318, then the icon control bar 210 may be digitally displayed on the display 318 and may optionally overlay the other displayed content on the display 318.

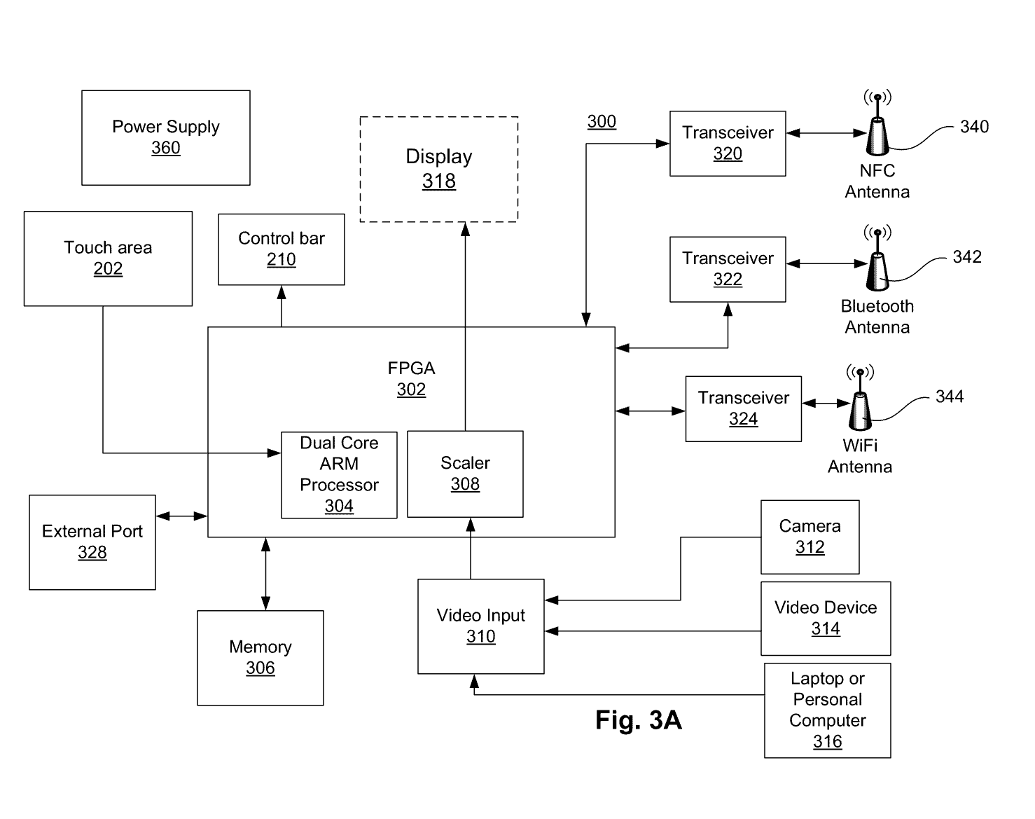

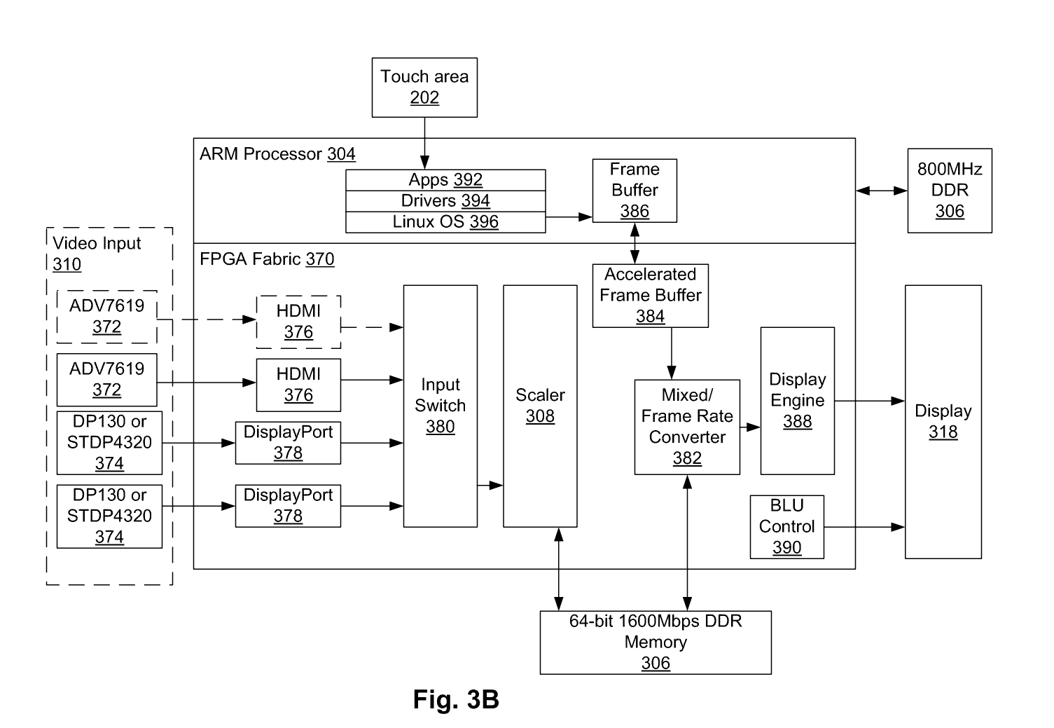

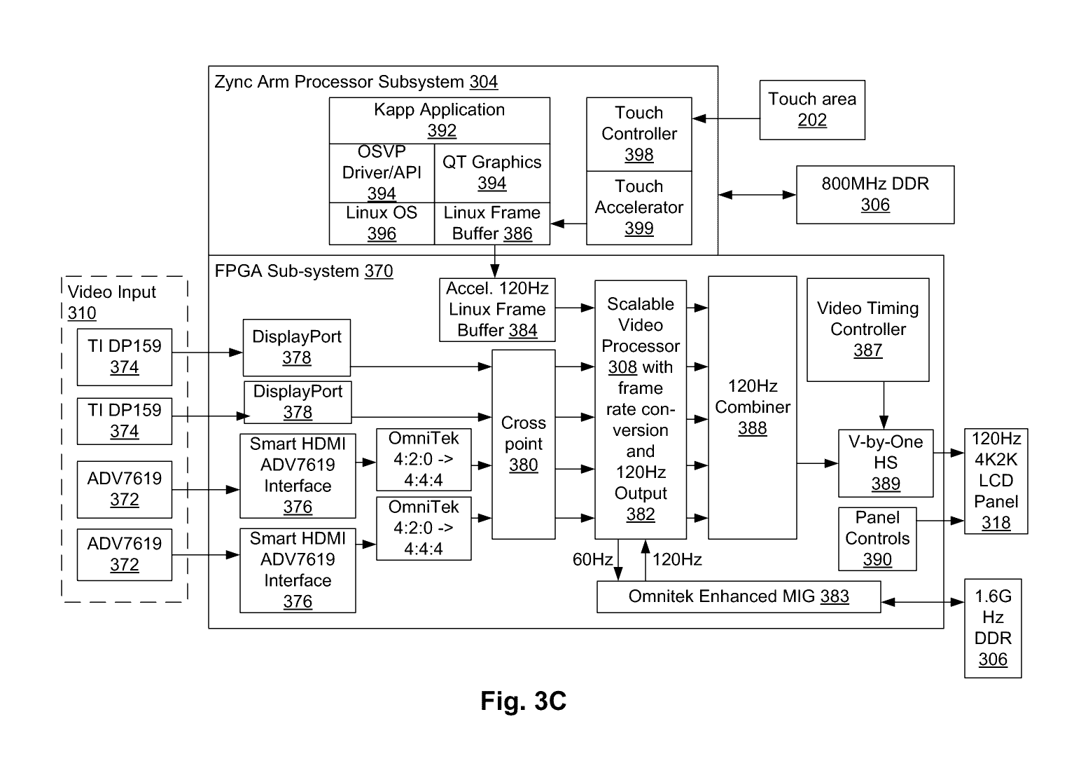

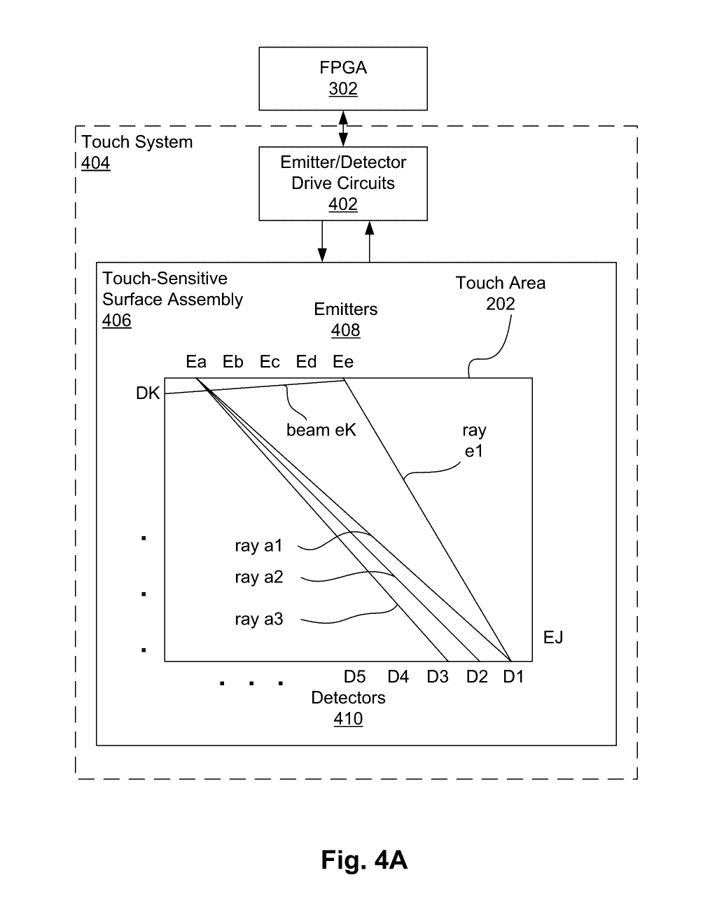

Turning to FIGS. 3A to 3C, the capture board 108 may be controlled with an field programmable gate array (FPGA) 302 or other processing structure which in this embodiment, comprises a dual core ARM Processor 304 executing instructions from volatile or non-volatile memory 306 and storing data thereto. The FPGA 302 may also comprises a scaler 308 which scales video inputs 310 to a format suitable for presenting on a display 318. The display 318 generally corresponds in approximate size and approximate shape to the touch area 202. The display 318 is typically a large-sized display for either presentation or collaboration with group of users. The resolution is sufficiently high to ensure readability of the display 318 by all participants. The video input 310 may be from a camera 312, a video device 314 such as a DVD player, Blu Ray player, VCR, etc, or a laptop or personal computer 316. The FPGA 302 communicates with the mobile device 105 (or other devices) using one or more transceivers such as, in this embodiment, an NFC transceiver 320 and antenna 340, a Bluetooth transceiver 322 and antenna 342, or a WiFi transceiver 324 and antenna 344. Optionally, the transceivers and antennas may be incorporated into a single transceiver and antenna. The FPGA 302 may also communicate with an external device 328 such as a USB memory storage device (not shown) where data may be stored thereto. A wired power supply 360 provides power to all the electronic components 300 of the capture board 108. The FPGA 302 interfaces with the previously mentioned icon control bar 210.

When the user contacts the pointer 204 with the touch area 202, the processor 304 tracks the motion of the pointer 204 and stores the pointer contacts in memory 306. Alternatively, the touch points may be stored as motion vectors or Bezier splines. The memory 306 therefore contains a digital representation of the drawn content within the touch area 202. Likewise, when the user contact the eraser 206 with the touch area 202, the processor 304 tracks the motion of the eraser 206 and removes drawn content from the digital representation of the drawn content. In this embodiment, the digital representation of the drawn content is stored in non-volatile memory 306.

When the pointer 204 contacts the touch area 202 in the location of the capture (or snapshot) icon 240, the FPGA 302 detects this contact as a control function which initiates the processor 304 to copy the currently stored digital representation of the drawn content to another location in memory 306 as a new page also known as a snapshot. The capture icon 240 may optionally flash during the saving of the digital representation of drawn content to another memory location. The FPGA 302 then initiates a snapshot message to one or more of the paired mobile device(s) 105 via the appropriately paired transceiver(s) 320, 322, and/or 324. The message contains an indication to the paired mobile device(s) 105 to capture the current image as a new page. Optionally, the message may also contain any changes that were made to the page after the last update sent to the mobile device(s) 105. The user may then continue to annotate or add content objects within the touch area 202. Optionally, once the transfer of the page to the paired mobile device 105 is complete, the page may be deleted from memory 306.

If a USB memory device (not shown) is connected to the external port 328, the FPGA 302 illuminates the USB device connection icon 242 in order to indicate to the user that the USB memory device is available to save the captured pages. When the user contacts the capture icon 240 with the pointer 204 and the USB memory device is present, the captured pages are transferred to the USB memory device as well as being transferred to any paired mobile device 105. The captured pages may be converted into another file format such as PDF, Evernote, XML, Microsoft Word®, Microsoft® Visio, Microsoft® Powerpoint, etc and if the file has previously been saved on the USB memory device, then the pages since the last save may be appended to the previously saved file. During a save to the USB memory, the USB device connection icon 242 may flash to indicate a save is in progress.

If the user contacts the USB device connection icon 242 using the pointer 204 and the USB memory device is present, the FPGA 302 flushes any data caches to the USB memory device and disconnects the USB memory device in the conventional manner. If an error is encountered with the USB memory device, the FPGA 302 may cause the USB device connection icon 242 to flash red. Possible errors may be the USB memory device being formatted in an incompatible format, communication error, or other type of hardware failure.

When one or more mobile devices 105 begins pairing with the capture board 108, the FPGA 302 causes the Bluetooth icon 244 to flash. Following connection, the FPGA 302 causes the Bluetooth icon 244 to remain active. When the pointer 204 contacts the Bluetooth icon 244, the FPGA 302 may disconnect all the paired mobile devices 105 or may disconnect the last connected mobile device 105. Optionally for capture boards 108 with a display 318, the FPGA 302 may display an onscreen menu on the display 318 prompting the user to select which mobile device 105 (or remotely connected device) to disconnect. When the mobile device 105 is disconnecting from the capture board 108, the Bluetooth icon 244 may flash red in colour. If all mobile devices 105 are disconnected, the Bluetooth icon 244 may be solid red or may not be illuminated.

When the FPGA 302 is powered and the capture board 108 is working properly, the FPGA 302 causes the system status icon 246 to become illuminated. If the FPGA 302 determines that one of the subsystems of the capture board 108 is not operational or is reporting an error, the FPGA 302 causes the system status icon 246 to flash. When the capture board 108 is not receiving power, all of the icons in the control bar 210 are not illuminated.

FIGS. 3B and 3C demonstrate examples of structures and interfaces of the FPGA 302. As previously mentioned, the FPGA 302 has an ARM Processor 304 embedded within it. The FPGA 302 also implements an FPGA Fabric or Sub-System 370 which, in this embodiment comprises mainly video scaling and processing. The video input 310 comprises receiving either High-Definition Multimedia Interface (HDMI) or DisplayPort, developed by the Video Electronics Standards Association (VESA), via one or more Xpressview 3 GHz HDMI receivers (ADV7619) 372 produced by Analog Devices, the Data Sheet and User Guide herein incorporated by reference, or one or more DisplayPort Re-driver (DP130 or DP159) 374 produced by Texas Instruments, the Data Sheet, Application Notes, User Guides, and Selection and Solution Guides herein incorporated by reference. These HDMI receivers 372 and DisplayPort re-drivers 374 interface with the FPGA 302 using corresponding circuitry implementing Smart HDMI Interfaces 376 and DisplayPort Interfaces 378 respectively. An input switch 380 detects and automatically selects the currently active video input. The input switch or crosspoint 380 passes the video signal to the scaler 308 which resizes the video to appropriately match the resolution of the currently connected display 318. Once the video is scaled, it is stored in memory 306 where it is retrieved by the mixed/frame rate converter 382.

The ARM Processor 304 has applications or services 392 executing thereon which interface with drivers 394 and the Linux Operating System 396. The Linux Operating System 396, drivers 394, and services 392 may initialize wireless stack libraries. For example, the protocols of the Bluetooth Standard, the Adopted Bluetooth Core Specification v 4.2 Master Table of Contents & Compliance Requirements herein incorporated by reference, may be initiated such as an radio frequency communication (RFCOMM) server, configure Service Discovery Protocol (SDP) records, configure a Generic Attribute Profile (GATT) server, manage network connections, reorder packets, transmit acknowledgements, in addition to the other functions described herein. The applications 392 alter the frame buffer 386 based on annotations entered by the user within the touch area 202.

A mixed/frame rate converter 382 overlays content generated by the Frame Buffer 386 and Accelerated Frame Buffer 384. The Frame Buffer 386 receives annotations and/or content objects from the touch controller 398. The Frame Buffer 386 transfers the annotation (or content object) data to be combined with the existing data in the Accelerated Frame Buffer 384. The converted video is then passed from the frame rate converter 382 to the display engine 388 which adjusts the pixels of the display 318.

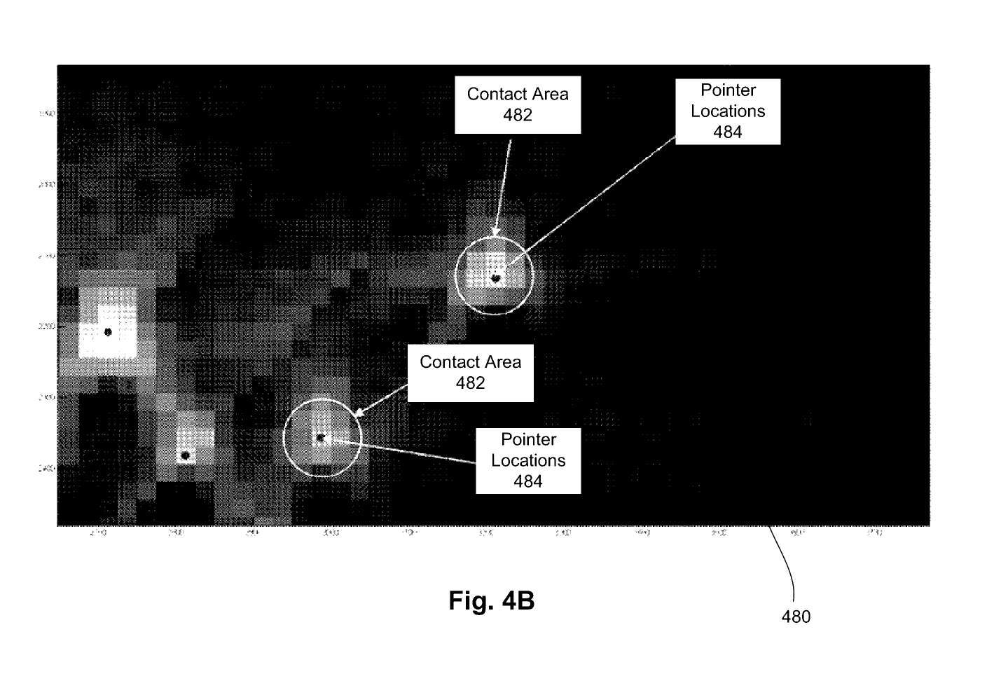

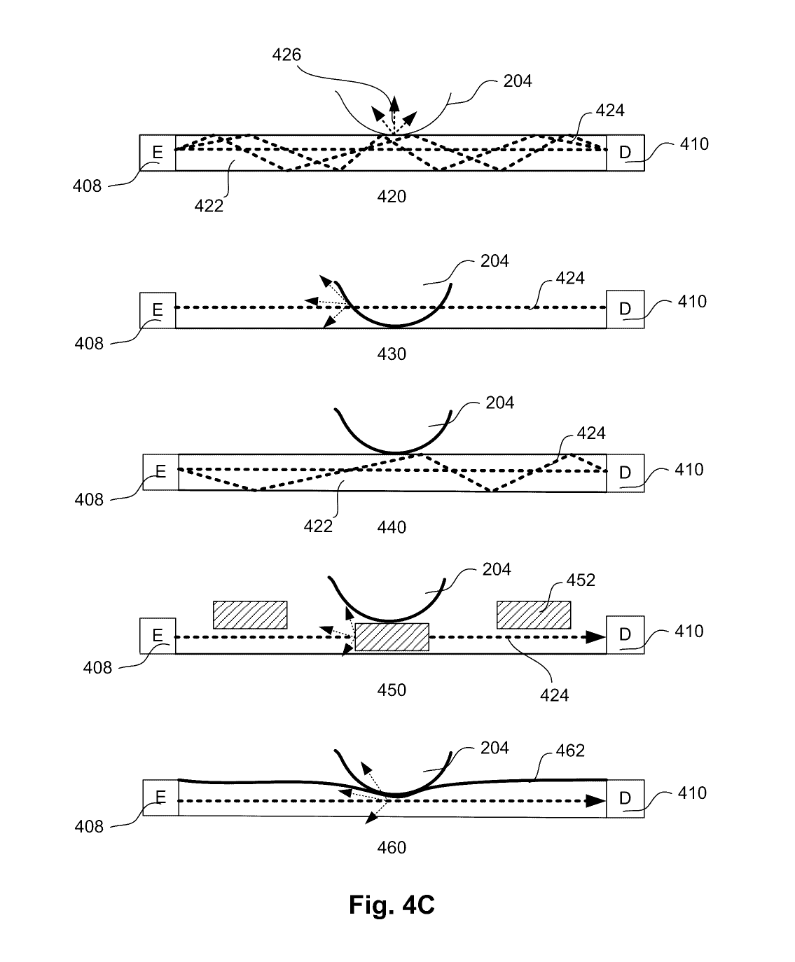

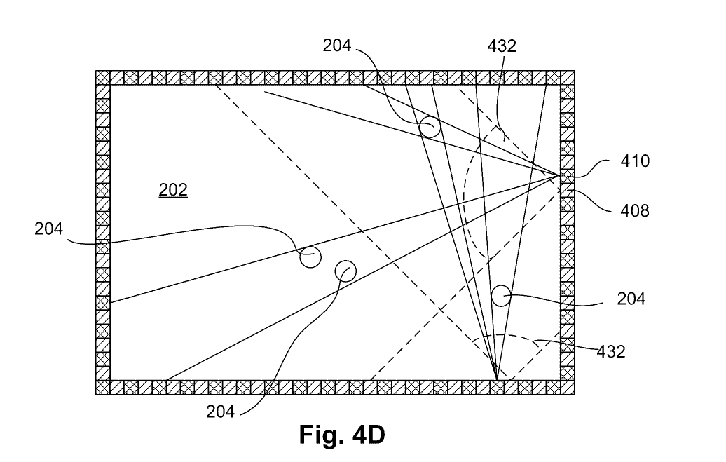

In FIG. 3C, a OmniTek Scalable Video Processing Suite, produced by OmniTek of the United Kingdom, the OSVP 2.0 Suite User Guide June 2014 herein incorporated by reference, is implemented. The scaler 308 and frame rate converter 382 are combined into a single processing block where each of the video inputs are processed independently and then combined using a 120 Hz Combiner 388. The scaler 308 may perform at least one of the following on the video: chroma upsampling, colour correction, deinterlacing, noise reduction, cropping, resizing, and/or any combination thereof. The scaled and combined video signal is then transmitted to the display 318 using a V-by-One HS interface 389 which is an electrical digital signaling standard that can run at up to 3.75 Gbit/s for each pair of conductors using a video timing controller 387. An additional feature of the embodiment shown in FIG. 3C is an enhanced Memory Interface Generator (MIG) 383 which optimizes memory bandwidth with the FPGA 302. The touch area 202 provides either transmittance coefficients to a touch controller 398 or may optionally provide raw electrical signals or images. The touch controller 398 then processes the transmittance coefficients to determine touch locations as further described below with reference to FIG. 4A to 4C. The touch accelerator 399 determines which pointer 204 is annotating or adding content objects and injects the annotations or content objects directly into the Linux Frame buffer 386 using the appropriate ink attributes.

The FPGA 302 may also contain backlight control unit (BLU) or panel control circuitry 390 which controls various aspects of the display 318 such as backlight, power switch, on-screen displays, etc.

The touch area 202 of the embodiment of the invention is observed with reference to FIGS. 4A to 4D and further disclosed in U.S. Pat. No. 8,723,840 to Rapt Touch, Inc. and Rapt IP Ltd respectively, the contents thereof incorporated by reference in their entirety. The FPGA 302 interfaces and controls the touch system 404 comprising emitter/detector drive circuits 402 and a touch-sensitive surface assembly 406. As previously mentioned, the touch area 202 is the surface on which touch events are to be detected. The surface assembly 406 includes emitters 408 and detectors 410 arranged around the periphery of the touch area 202. In this example, there are K detectors identified as D1 to DK and J emitters identified as Ea to EJ. The emitter/detector drive circuits 402 provide an interface between the FPGA 302 whereby the FPGA 302 is able to independently control and power the emitters 408 and detectors 410. The emitters 408 produce a fan of illumination generally in the infrared (IR) band whereby the light produced by one emitter 408 may be received by more than one detector 410. A “ray of light” refers to the light path from one emitter to one detector irrespective of the fan of illumination being received at other detectors. The ray from emitter Ej to detector Dk is referred to as ray jk. In the present example, rays a1, a2, a3, e1 and eK are examples.

When the pointer 204 contact the touch area 202, the fan of light produced by the emitter(s) 408 is disturbed thus changing the intensity of the ray of light received at each of the detectors 410. The FPGA 302 calculates a transmission coefficient Tjk for each ray in order to determine the location and times of contacts with the touch area 202. The transmission coefficient Tjk is the transmittance of the ray from the emitter j to the detector k in comparison to a baseline transmittance for the ray. The baseline transmittance for the ray is the transmittance measured when there is no pointer 204 interacting with the touch area 202. The baseline transmittance may be based on the average of previously recorded transmittance measurements or may be a threshold of transmittance measurements determined during a calibration phase. The inventor also contemplates that other measures may be used in place of transmittance such as absorption, attenuation, reflection, scattering, or intensity.

The FPGA 302 then processes the transmittance coefficients Tjk from a plurality of rays and determines touch regions corresponding to one or more pointers 204. Optionally, the FPGA 302 may also calculate one or more physical attributes such as contact pressure, pressure gradients, spatial pressure distributions, pointer type, pointer size, pointer shape, determination of glyph or icon or other identifiable pattern on pointer, etc.

Based on the transmittance coefficients Tjk for each of the rays, a transmittance map is generated by the FPGA 302 such as shown in FIG. 4B. The transmittance map 480 is a grayscale image whereby each pixel in the grayscale image represents a different “binding value” and in this embodiment each pixel has a width and breadth of 2.5 mm. Contact areas 482 are represented as white areas and non-contact areas are represented as dark gray or black areas. The contact areas 482 are determined using various machine vision techniques such as, for example, pattern recognition, filtering, or peak finding. The pointer locations 484 are determined using a method such as peak finding where one or more maximums is detected in the 2D transmittance map within the contact areas 482. Once the pointer locations 484 are known in the transmittance map 480, these locations 484 may be triangulated and referenced to locations on the display 318 (if present). Methods for determining these contact locations 484 are disclosed in U.S. Patent Publication No. 2014/0152624, herein incorporated by reference.

Five example configurations for the touch area 202 are presented in FIG. 4C. Configurations 420 to 440 are configurations whereby the pointer 204 interacts directly with the illumination being generated by the emitters 408. Configurations 450 and 460 are configurations whereby the pointer 204 interacts with an intermediate structure in order to influence the emitted light rays.

A frustrated total internal reflection (FTIR) configuration 420 has the emitters 408 and detectors 410 optically mated to an optically transparent waveguide 422 made of glass or plastic. The light rays 424 enter the waveguide 422 and is confined to the waveguide 422 by total internal reflection (TIR). The pointer 204 having a higher refractive index than air comes into contact with the waveguide 422. The increase in the refractive index at the contact area 482 causes the light to leak 426 from the waveguide 422. The light loss attenuates rays 424 passing through the contact area 482 resulting in less light intensity received at the detectors 410.

A beam blockage configuration 430, further shown in more detail with respect to FIG. 4D, has emitters 408 providing illumination over the touch area 202 to be received at detectors 410 receiving illumination passing over the touch area 202. The emitter(s) 408 has an illumination field 432 of approximately 90-degrees that illuminates a plurality of pointers 204. The pointer 204 enters the area above the touch area 202 whereby it partially or entirely blocks the rays 424 passing through the contact area 482. The detectors 410 similarly have an approximately 90-degree field of view and receive illumination either from the emitters 408 opposite thereto or receive reflected illumination from the pointers 204 in the case of a reflective or retro-reflective pointer 204. The emitters 408 are illuminated one at a time or a few at a time and measurements are taken at each of the receivers to generate a similar transmittance map as shown in FIG. 4B.

Another total internal reflection (TIR) configuration 440 is based on propagation angle. The ray is guided in the waveguide 422 via TIR where the ray hits the waveguide-air interface at a certain angle and is reflected back at the same angle. Pointer 204 contact with the waveguide 422 steepens the propagation angle for rays passing through the contact area 482. The detector 410 receives a response that varies as a function of the angle of propagation.

The configuration 450 show an example of using an intermediate structure 452 to block or attenuate the light passing through the contact area 482. When the pointer 204 contacts the intermediate structure 452, the intermediate structure 452 moves into the touch area 202 causing the structure 452 to partially or entirely block the rays passing through the contact area 482. In another alternative, the pointer 204 may pull the intermediate structure 452 by way of magnetic force towards the pointer 204 causing the light to be blocked.

In an alternative configuration 460, the intermediate structure 452 may be a continuous structure 462 rather than the discrete structure 452 shown for configuration 450. The intermediate structure 452 is a compressible sheet 462 that when contacted by the pointer 204 causes the sheet 462 to deform into the path of the light. Any rays 424 passing through the contact area 482 are attenuated based on the optical attributes of the sheet 462. In embodiments where a display 318 is present, the sheet 462 is transparent. Other alternative configurations for the touch system are described in U.S. patent Publication Ser. No. 14/452,882 and U.S. patent Publication Ser. No. 14/231,154, both of which are herein incorporated by reference in their entirety.

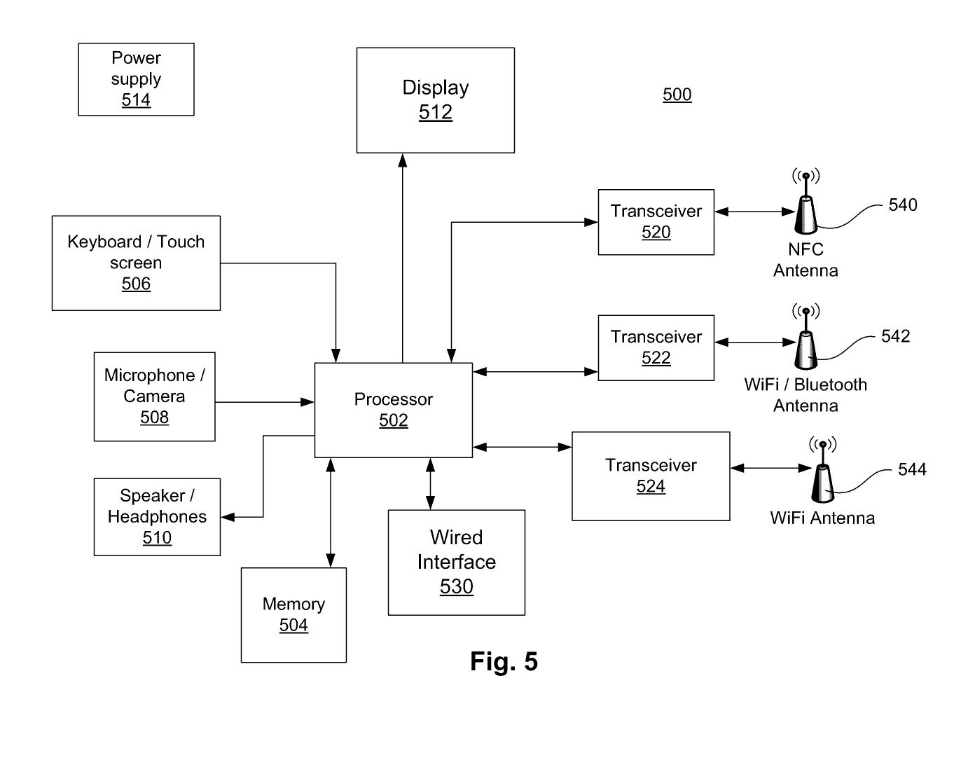

The components of an example mobile device 500 is further disclosed in FIG. 5 having a processor 502 executing instructions from volatile or non-volatile memory 504 and storing data thereto. The mobile device 500 has a number of human-computer interfaces such as a keypad or touch screen 506, a microphone and/or camera 508, a speaker or headphones 510, and a display 512, or any combinations thereof. The mobile device has a battery 514 supplying power to all the electronic components within the device. The battery 514 may be charged using wired or wireless charging.

The keyboard 506 could be a conventional keyboard found on most laptop computers or a soft-form keyboard constructed of flexible silicone material. The keyboard 506 could be a standard-sized 101-key or 104-key keyboard, a laptop-sized keyboard lacking a number pad, a handheld keyboard, a thumb-sized keyboard or a chorded keyboard known in the art. Alternatively, the mobile device 500 could have only a virtual keyboard displayed on the display 512 and uses a touch screen 506. The touch screen 506 can be any type of touch technology such as analog resistive, capacitive, projected capacitive, ultrasonic, infrared grid, camera-based (across touch surface, at the touch surface, away from the display, etc), in-cell optical, in-cell capacitive, in-cell resistive, electromagnetic, time-of-flight, frustrated total internal reflection (FTIR), diffused surface illumination, surface acoustic wave, bending wave touch, acoustic pulse recognition, force-sensing touch technology, or any other touch technology known in the art. The touch screen 506 could be a single touch or multi-touch screen. Alternatively, the microphone 508 may be used for input into the mobile device 500 using voice recognition.

The display 512 is typically small-size between the range of 1.5 inches to 14 inches to enable portability and has a resolution high enough to ensure readability of the display 512 at in-use distances. The display 512 could be a liquid crystal display (LCD) of any type, plasma, e-Ink®, projected, or any other display technology known in the art. If a touch screen 506 is present in the device, the display 512 is typically sized to be approximately the same size as the touch screen 506. The processor 502 generates a user interface for presentation on the display 512. The user controls the information displayed on the display 512 using either the touch screen or the keyboard 506 in conjunction with the user interface. Alternatively, the mobile device 500 may not have a display 512 and rely on sound through the speakers 510 or other display devices to present information.

The mobile device 500 has a number of network transceivers coupled to antennas for the processor to communicate with other devices. For example, the mobile device 500 may have a near-field communication (NFC) transceiver 520 and antenna 540; a WiFi®/Bluetooth® transceiver 522 and antenna 542; a cellular transceiver 524 and antenna 544 where at least one of the transceivers is a pairing transceiver used to pair devices. The mobile device 500 optionally also has a wired interface 530 such as USB or Ethernet connection.

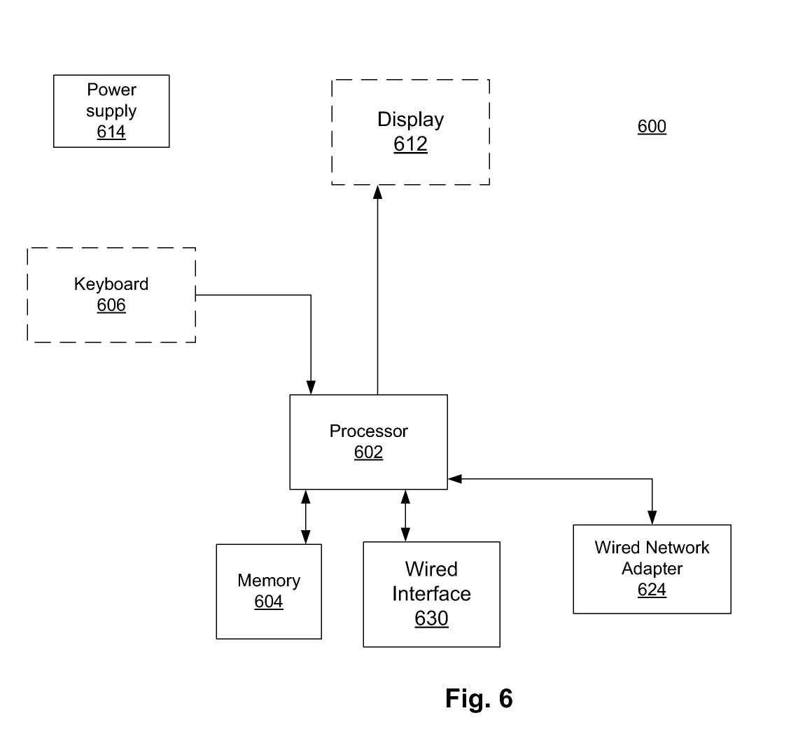

The servers 120, 122, 124 shown in FIG. 6 of the present embodiment have a similar structure to each other. The servers 120, 122, 124 have a processor 602 executing instructions from volatile or non-volatile memory 604 and storing data thereto. The servers 120, 122, 124 may or may not have a keyboard 306 and/or a display 312. The servers 120, 122, 124 communicate over the Internet 150 using the wired network adapter 624 to exchange information with the paired mobile device 105 and/or the capture board 108, conferencing, and sharing of captured content. The servers 120, 122, 124 may also have a wired interface 630 for connecting to backup storage devices or other type of peripheral known in the art. A wired power supply 614 supplies power to all of the electronic components of the servers 120, 122, 124.

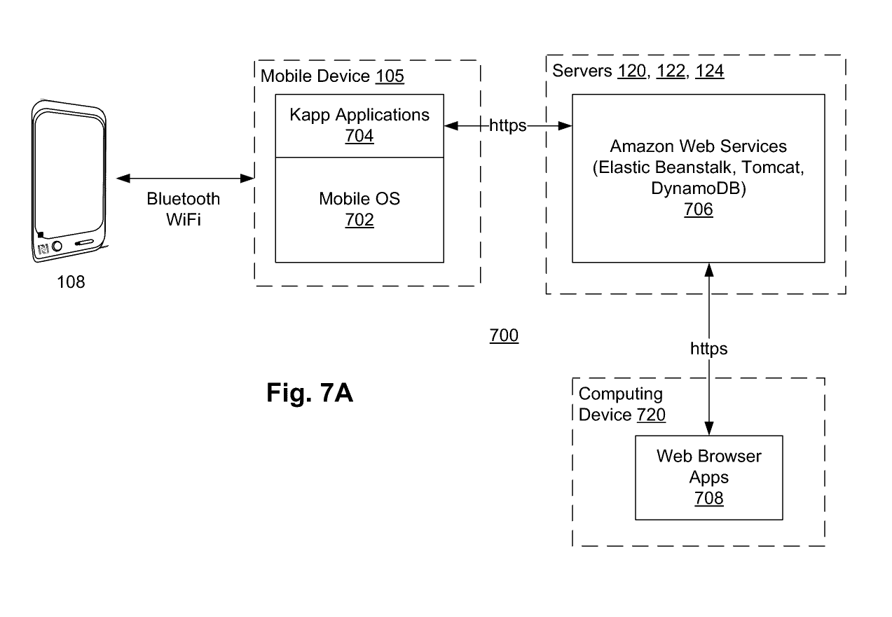

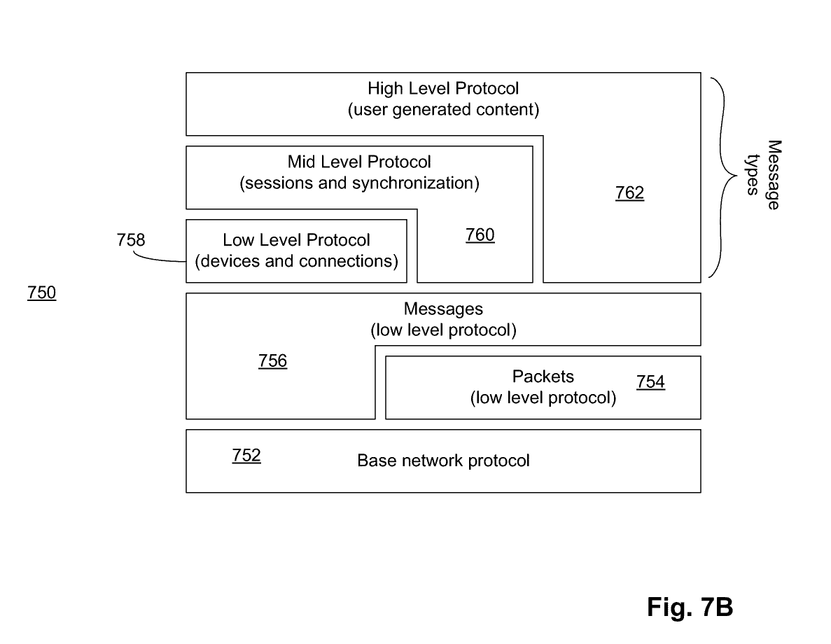

An overview of the system architecture 700 is presented in FIGS. 7A and 7B. The capture board 108 is paired with the mobile device 105 to create one or more wireless communications channels between the two devices. The mobile device 105 executes a mobile operating system (OS) 702 which generally manages the operation and hardware of the mobile device 105 and provides services for software applications 704 executing thereon. The software applications 704 communicate with the servers 120, 122, 124 executing a cloud-based execution and storage platform 706, such as for example Amazon Web Services, Elastic Beanstalk, Tomcat, DynamoDB, etc, using a secure hypertext transfer protocol (https). Any content stored on the cloud-based execution and storage platform 706 may be accessed using an HTML5-capable web browser application 708, such as Chrome, Internet Explorer, Firefox, etc, executing on a computer device 720. When the mobile device 105 connects to the capture board 108 and the servers 120, 122, 124, a session is generated as further described below. Each session has a unique session identifier.

FIG. 7B shows an example protocol stack 750 used by the devices connected to the session. The base network protocol layer 752 generally corresponds to the underlying communication protocol, such as for example, Bluetooth, WiFi Direct, WiFi, USB, Wireless USB, TCP/IP, UDP/IP, etc. and may vary based by the type of device. The packets layer 754 implement secure, in-order, reliable stream-oriented full-duplex communication when the base networking protocol 752 does not provide this functionality. The packets layer 754 may be optional depending on the underlying base network protocol layer 752. The messages layer 756 in particular handles all routing and communication of messages to the other devices in the session. The low level protocol layer 758 handles redirecting devices to other connections. The mid level protocol layer 760 handles the setup and synchronization of sessions. The High Level Protocol 762 handles messages relating the user generated content as further described herein. These layers are discussed in more detail below.

Turning now to FIG. 8A, as previously mentioned uses a pairing URL for connection of the mobile device 105 to the capture board 108. Typically, a service executing on the mobile device 105 either scans the QR code 212 or NFC tag 214 which retrieves the pairing URL (step 804). Once retrieved, the pairing URL is normalized in order to extract the board ID portion (step 806). The normalization may involve one or more of the following steps: applying a Unicode Normalization Form NFC; converting all alphabetic characters to lower-case; decoding any URI encoded characters; trimming leading and trailing whitespace; verifying the URL leads with either http:// or https:// and if not, appending http:// thereto; and verifying the validity of the hostname such as “www.kappboard.com” or “kappboard.com”. For the board ID portion, one or more of the following additional steps may performed: replacing U+0031 (DIGIT ONE) with U+0069 (LATIN SMALL LETTER I); replacing U+006C (LATIN SMALL LETTER L) with U+006A (LATIN SMALL LETTER J); replacing U+0030 (DIGIT ZERO) with U+006F (LATIN SMALL LETTER O); and removing all punctuation.

If the pairing URL is not associated with any applications on the mobile device 105 (step 808), the pairing URL directs a browser executing on the mobile device 105 to a web site inviting the user to download a dedicated application for interfacing with the capture board 108 (step 810). If the dedicated application is already installed (step 808), the pairing URL will have been previously associated with the dedicated application. The operating system executing on the mobile device 105 initiates the dedicated application (step 812) and passes the pairing URL thereto as an execution parameter. The dedicated application decodes the Bluetooth address (or other equivalent wireless address) based on the board ID and thereby optimizes the connection processes (step 814). In typical cases, the connection time is reduced from 7000 msec to about 300 msec. Alternatively, the user may enter the pairing URL manually into the mobile device 105.

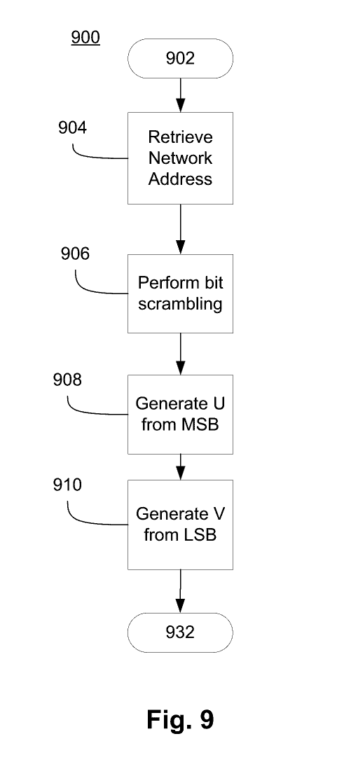

In this embodiment, the 10-character board ID is derived from the 48-bit Bluetooth address in the following manner as shown in FIG. 9. The encoding algorithm is selected so that similar Bluetooth addresses are encoded to significantly different board IDs. The encoding scheme also generates board IDs comprising only letters and numbers, are case-insensitive, appear random, and account for common human transcription errors (e.g. digit zero “0” and letter “o”). The board ID always starts with a letter. The encoding algorithm may be executed at the manufacturing facility or may be generated at the time of registration of the capture board 108. In this example, the unique QR code is printed and affixed to the capture board 108. A manufacturing test station running manufacturing software loads firmware into the memory 306 of the capture board 108 and scans the QR code to determine the assigned address. This address is then programmed into the firmware and the NFC tag. For capture boards 108 having a display 318, the unique QR code is displayed on the display 318.

The encoding algorithm uses the 48-bit Bluetooth address P retrieved from the Bluetooth transceiver 322 as a 48-bit number in network byte order as in input (step 904). A bit scrambling function is applied to compute an intermediate 48-bit number Q (step 906). The number Q is constructed using a translation array K. Once Q has been determined, the three most significant bits (MSB) are used as an index for the U array comprising only letters making the lead character of the board ID one of these characters. The remaining 45-bits of Q are divided into nine 5-bit numbers in MSB order (step 910). Each 5-bit number is used as an index for an array V comprising alphanumeric values.

Returning to FIGS. 8A and 8B, the dedicated application executing on the mobile device 105 decodes the board ID portion of the pairing URL (step 814) by inverse generation of the 48-bit intermediate number Q. Once the intermediate number Q has been calculated, it is used to generate the 48-bit number P using the inverse translation array K.

Once the Bluetooth MAC address of the capture board 108 is known to the dedicated application, the dedicated application is able to connect with the capture board 108 without requiring a personal identification number (PIN) or other pass code (step 816). The dedicated application implements a communication protocol at the Layer 7 of the Open Systems Interconnection (OSI) model and assumes that the lower layers provide a minimum of unreliable delivery of connectionless datagrams. The lower layers are also assumed to be unsecure. In this embodiment, a Bluetooth protocol is used for the lower layers but the inventor contemplates that other communication protocols may be suitable such as RFCOMM (Bluetooth Classic), GATT (Bluetooth LE), TCP/IP, UDP/IP, USB, wireless USB, etc. The dedicated application and capture board 108 implement a protocol having at least one protocol rule which provides a secure, reliable byte stream-oriented channel by exchanging messages comprising one or more fixed-length packets. Message security and endpoint authorization are implemented by the protocol even though it may be provided by the lower layers.

The capture board is discoverable at all times and advertises an SDP record for an insecure RFCOMM service with a Universally Unique Identifier (UUID) while no mobile device 105 is connected.

A second service may optionally be registered using a different UUID that upon accepting a connection, transmits a message containing the device information such as a make, model, and/or serial number as well as operational status (step 818). The connection may subsequently be closed. Alternatively, the second service may transmit, in order, a session redirection message, a device status message, and one or more thumbnail metadata messages to transmit the thumbnail images to the mobile device 105. The session redirection message directs the connecting mobile device 105 to a web-sharing session when the capture board 108 is already in use (step 820). If the capture board 108 is in use, then the dedicated application performs a protocol upgrade (step 822) that modifies how the dedicated application communicates with other devices. The dedicated application then receives a session redirection message (step 824) and connects thereto via the web address (step 826).

If the capture board 108 is not in use, the dedicated application on the mobile device 105 is authenticated with the capture board 108 (step 830) as further described below. Once authenticated, the dedicated application requests a protocol upgrade 822 which may upgrade the dedicated application to the highest protocol level permissible by the capture board 108. The dedicated application synchronizes clocks (step 834) and performs address allocation (step 836) as described further below. The dedicated application then retrieves (or receives) the contents currently on the capture board 108 (step 834). The dedicated application continues to retrieve (or receive) (step 838) the content objects generated by the capture board 108 until the session is ended (step 840) by either the dedicated application, servers 120, 122, 124, and/or capture board 108. When the session is ended, the dedicated application saves the session information (step 842) and closes the connection (step 844).

Since the capture board 108 may or may not have a display and may be limited to only pointer 204 input, the capture board 108 in this embodiment implements insecure RFCOMM protocol connections. The RFCOMM protocol emulates the serial cable line settings and status of an RS-232 serial port and is used for providing serial data transfer. The capture board 108 may also implement the Bluetooth Simple Secure Pairing mechanism or the Push Button method for Wi-Fi Protected Setup (used in Wi-Fi Direct). These methods permit underlying transport layer connection without requiring the user to enter a PIN or passkey. If passkey authentication is required by the underlying transport layer (e.g., in order to achieve compliance with legacy Bluetooth and Baseline Wi-Fi Direct specifications) the passkey chosen may be the hardcoded device-specific portion of the pairing URL of the capture board 108.

Since the underlying transport layer does not require a passkey (or uses a hardcoded passkey) this protocol has a mechanism to further control access to device functions by requiring the dedicated application to prompt the user for a passkey before sending certain kinds of messages. Two levels of passkey protection are provided: connection and configuration. It is possible for the connection passkey to be different from the configuration passkey, and it is possible to set a connection passkey and not set a configuration passkey: in this case, everyone who provides the correct connection passkey is also capable of configuration.

When connection requires a passkey, the capture board 108 may silently ignore all notifications and negatively respond to requests not pertinent to the tasks of maintaining the open session and providing proof of a valid connection passkey. When configuration requires a passkey, the capture board 108 may silently ignore notifications and negatively respond to requests to alter the device configuration until such time a valid passkey is provided.

The communication session between the mobile device 105 and the capture board 108 begins (step 816) by setting up the session using a three-way handshake similar to that used to set up TCP/IP connections, as further described in RFC793 Transmission Control Protocol DARPA Internet Protocol Specification 1981 herein incorporated by reference. This handshake is performed even if made redundant by lower layers in the protocol stack as the underlying protocol layers may not be known and may not provide this type of handshake. Likewise, the session teardown uses a similar four-way handshake used to tear down TCP/IP connections. As is in the case of TCP/IP, it is possible to bypass the four-way handshake and rely on timeouts on packet acknowledgements to indicate when the mobile device 105 have moved out of range.

For a capture board 108 using Bluetooth RFCOMM, which typically only handles one connected client at a time, when a mobile device 105 connects to the capture board 108, the capture board 108 stops advertising the first and second services to ensure other clients quickly determine that the capture board 108 is unavailable. The connected mobile device 105 then subsequently relays messages received from other devices 105 and/or 108 in the session by way of the redirected session. If the implementation permits more than one mobile device 105 connection, the mobile devices 105 should initiate a device information query (step 818) and a protocol upgrade (step 822) (described below) in order to secure an alternative connection to the session.

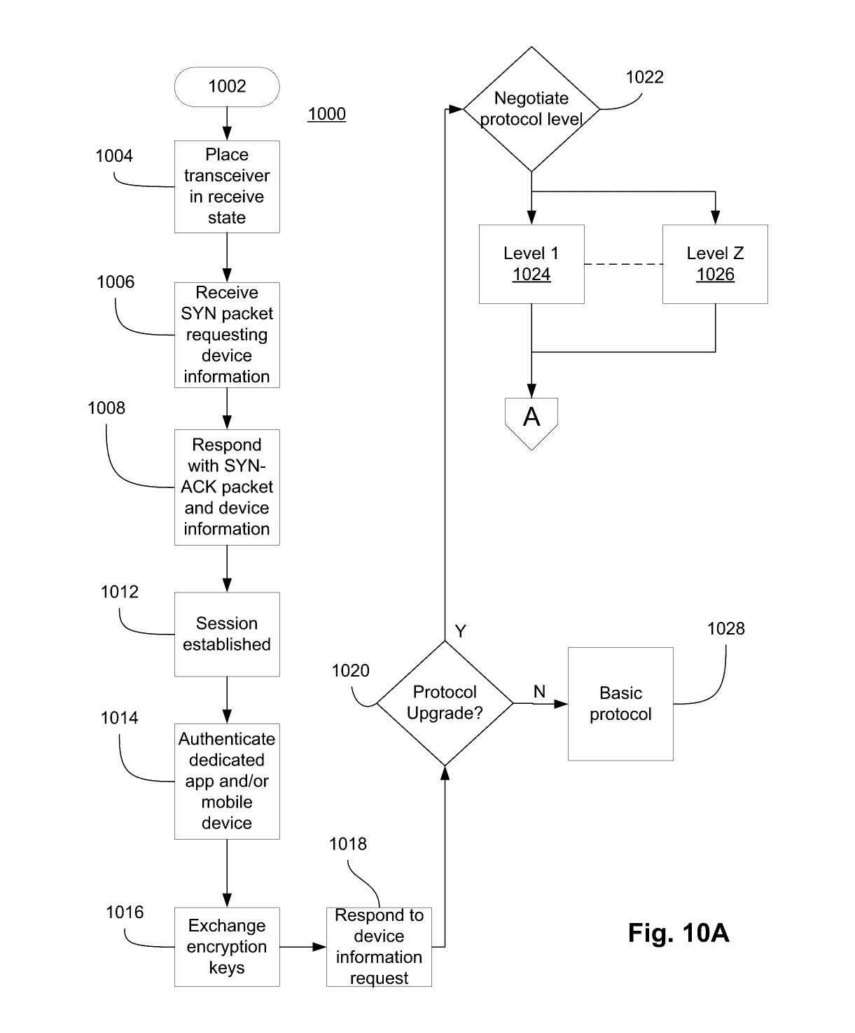

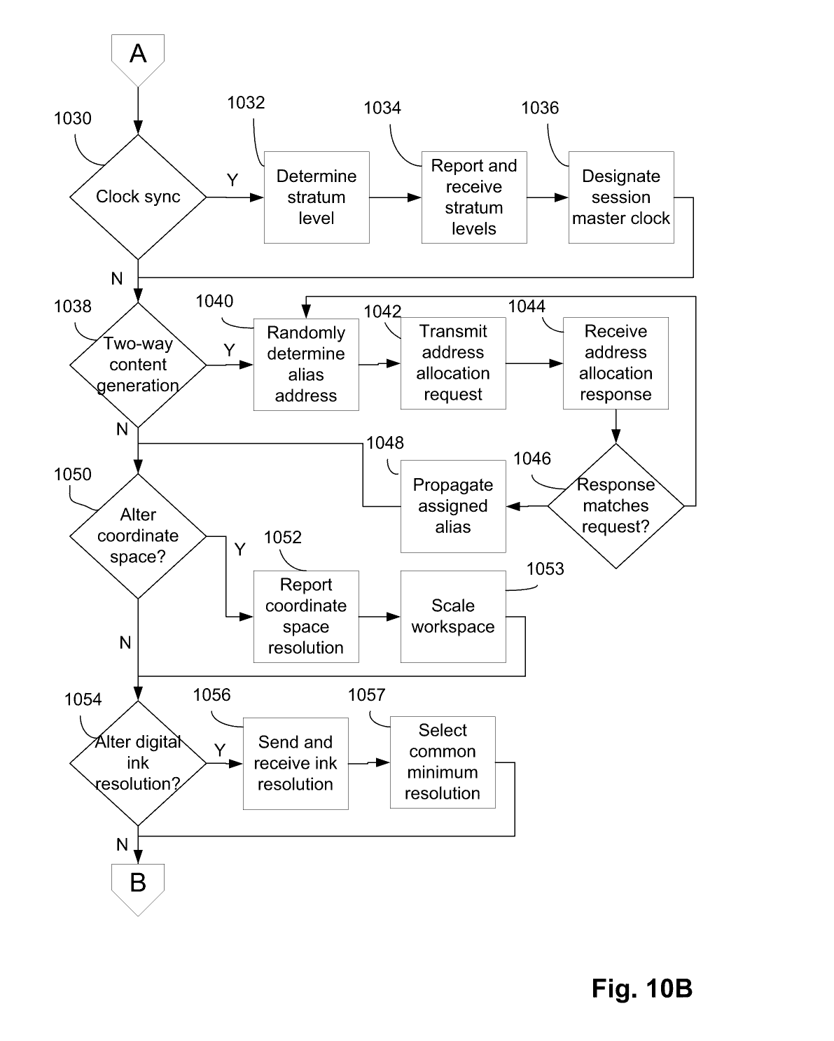

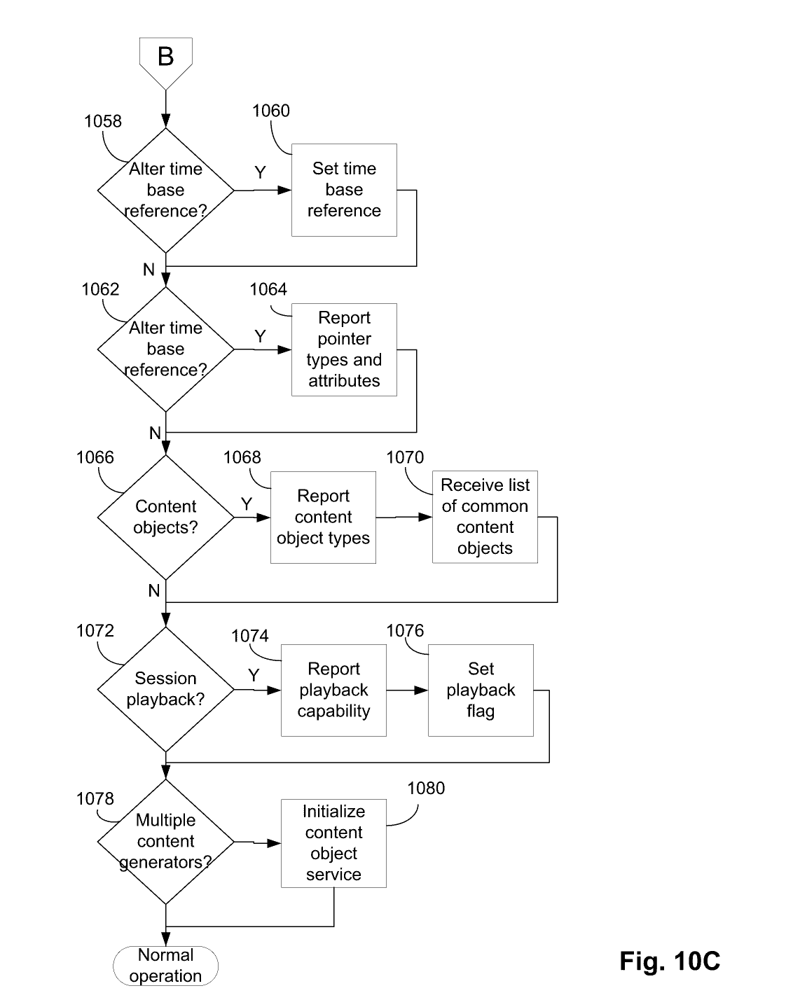

Turning now to FIGS. 10A and 10B, in order to initiate the session, the FPGA 302 of the capture board 108 places one or more of the transceivers 322, 324 into a receive state where it may receive messages from any other party such as one or more of the mobile devices 105 (step 1004). The dedicated application transmits a SYN packet using one of its transceivers 522 or 524 to the capture board 108. The SYN packet comprises a non-zero SYN flag and an initial packet sequence number of the mobile device 105. The initial packet sequence number may be randomly selected. It is preferable that the SYN packet further comprises a device information request message querying the capture board 108 to provide information pertaining to the capture board 108 such as model number, serial number, firmware version, connection requirements, etc (step 1006).

On receipt of the SYN packet, the capture board 108 responds with a SYN-ACK packet which has both the SYN and ACK flags set to non-zero, has the ackNum field set to the seqNum field of the SYN packet and has the seqNum field set to an initial sequence number for the capture board 108, which may be chosen randomly and may be different from that specified by the mobile device 105. Preferably, the SYN-ACK packet may include a device information response message (affirmative or negative) in the SYN-ACK packet if the SYN packet included a request (step 1008). Once the mobile device 105 receives the SYN-ACK packet, the session is established (step 1012).

Alternatively, an existing session may be joined by the session generated by the mobile device 105 and capture board 108. The dedicated application on the mobile device 105, the capture board 108, or both may have a user interface on their respective display 512, 318 providing the user with the ability to search session metadata. The user enters information into the user interface pertaining to the desired session such as session name, session password, session location, etc. The device 105 or 108 then submits a query to the session server 122 which conducts a search of currently running, pre-existing, or future sessions and returns a list to the device 105 or 108 for display. The user then selects the appropriate session from the list which causes a connection thereto. The session of the mobile device 105 may then be synchronized with the existing session.

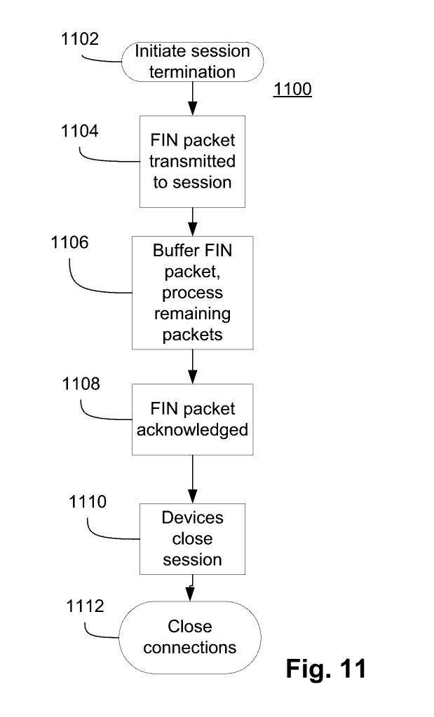

Session termination is shown in FIG. 11 where the mobile device 105 or the capture board 108 may initiate session termination (step 1102). One of the parties sends a FIN packet having a FIN flag set to a non-zero value (step 1104). In this example, the mobile device 105 transmits a FIN packet to the capture board 108. The capture board 108 receives the FIN packet and buffers the packet so it may be processed in order (step 1106). Premature processing of the FIN packet may result in loss of information if not processed in order. The capture board 108 transmits an ACK packet and a FIN packet to the mobile device 105, these two packets may be combined into a single FIN-ACK packet. The mobile device 105 then acknowledges the FIN packet from the capture board 108 normally by way of an ACK packet (step 1108). In response to the ACK packet, the capture board 108 (and/or other devices in the session) begins closing the session (step 1110) and finally the connection is closed (step 1112).

If the underlying network layer provides a reliable, connection-oriented semantics, the mobile device 105 may close the session as soon as the ACK packet for the FIN packet from the capture board 108 is sent. Otherwise, the mobile device 105 may wait a short duration (e.g. between 2000 ms and 4000 ms) before closing the session. This waiting period may be necessary in order for the capture board 108 to retransmit packets for which it failed to receive acknowledgements.

As the lower protocols are assumed to be connectionless and unreliable, the dedicated application uses a sequence number (seqNum) ranging from 0x001 to 0xFFE for each data packet sent. When the sequence number reaches 0xFFE, it may wrap around to 0x001. The mobile device 105 and the capture board 108 buffer the received data packets for reordering. Periodically, the reordered buffered packets are acknowledged by setting an acknowledgement field (ackNum) in an acknowledgement packet to the last sequence number of the series of buffered packets. This acknowledgement confirms the receipt of the packet indicated by ackNum and all preceding packets. Preferably, the acknowledgement packet is transmitted within 500 ms of receipt of the received data packet and received within 1000 ms. If the acknowledgement packet is not received within this period, the data packet is retransmitted. Retransmission of a packet may not be attempted more than 25 times. If an acknowledgement is not received after 25 retransmissions, the session is terminated.

In some embodiments, an acknowledgement-only packet may be sent which has the sequence number field cleared to zero with no payload and not encrypted. In addition to seqNum=0, a special value seqNum=0xFFF is reserved for application-internal use. For example, seqNum=0xFFF may indicate a packet that does not need to be acknowledged.

The dedicated application may also detect disconnection by way of keep alive packets. If the mobile device 105 or the capture board 108 has not received a packet within 25 seconds, the session may be terminated without a handshake. The keep alive packets may comprise sending the device status messages on a periodic basis of less than 25 seconds

In this embodiment, data packets may be 100-byte fixed-length chunks and transmitted at a maximum of 40 packets/second. The structure of a packet comprises: a fixed length header (32 bits); an optional, variable-length sequence of packet options (0 to 95 bytes); and the packet payload (messages). This structure is similar to the structure of TCP/IP packets in that they both provide reliable setup and teardown of sessions and in-order delivery of messages. All 96 bytes following the packet header are preferably encrypted whereas the packet header is never encrypted.

In order to secure the session to include only valid devices 105 and/or 108 and valid dedicated applications executing thereon, authentication may be performed on the mobile device 105 and the capture board 108 using public/private key pairs and digital signatures (steps 830 and 1014). The public/private key pairs for signing data may be 256-bit Elliptic Curve (EC) keys using the NIST standard prime-field curve with OID 1.2.840.10045.3.1.7 known variously as prime256v1 or secp256r1 or P-256 and may be combined with SHA-1 message digest (hash) function known as SHA1 with ECDSA in the Java Cryptography Architecture Standard Algorithm Name Documentation or EC(P)SP-DSA/EC(P)VP-DSA in IEEE Std 1363-2000a:2004.

For endpoint validation and authentication, public/private key pairs may use asymmetric encryption of 2048-bit RSA “two-prime” where packets may be padded using the Optimal Asymmetric Encryption Padding (OAEP) encoding method with SHA-1 hash algorithm and MGF1 mask generation function as given in the PCKS #1 v2.2 standard, herein incorporated by reference. This encryption scheme may be known as: RSA/ECB/OAEP with SHA-1 and MGF1 Padding in the Java Cryptography Architecture Standard Algorithm Name Documentation; RSAES-OAEP in IETF RFC 3447; or IFEP-RSA and IFDP-RSA in IEEE Std 1363-2000, all of which are herein incorporated by reference.

Data packet payloads may be encrypted with a symmetric block cipher such as AES cipher with 128-bit keys operating in Cipher Block Chaining (CBC) mode with no padding such as described in the Java Cryptography Architecture Standard Algorithm Name Documentation, herein incorporated by reference. The initialization vector (IV) and key for the AES cipher may be exchanged as part of the endpoint authentication process (step 1016). The integrity of some of the data packets may use hashes or checksums. These hashes may be generated using MD5 algorithm as described in IETF RFC 1321, herein incorporated by reference; SHA-1 and SHA-256 algorithms as described in NIST FIPS 180 Secure Hash Standard, herein incorporated by reference. The checksums may be generated using the CRC16-CCITT algorithm. The checksum field of the packet header is the low-order 4-bits of the CRC16-CCITT checksum computed over the entire 100 bytes of the packet. The checksum may be calculated after encryption. Before calculating the checksum, the checksum field is cleared to zero. The checksum is computed according to the method given in ITU-T Rec. V.41 (Code-Independent Error-Control System) except that the bits of the shift register are set to all 1s instead of being cleared to zero. Bits are shifted in/out of the register in most-significant bit order as given in ITU-T V.41 and the polynomial used is x16+x12+x5+1.

Returning to FIG. 10A, in order to accommodate different types of capture boards 108, such as for example boards with or without displays, differing hardware capabilities, etc, the communication protocol may be optimized through a protocol level negotiation. On connection establishment, all devices assume a basic level protocol. The dedicated application executing on the mobile device 105 transmits a device information request in order to obtain information from the capture board 108. In response, the capture board 108 indicates if it is capable of higher level protocols (step 1018). The dedicated application may, at its discretion, choose to upgrade the session to the higher level protocol by transmitting a protocol upgrade request message (step 1020). If the capture board 108 is unable to upgrade the session to a higher level, the capture board 108 returns a negative response and the protocol level remains at the basic level (step 1028). Any change in protocol options is assumed to take effect with the packet immediately following the affirmative response message being received from the capture board 108.

The protocol level may be specified using a “tag” with an associated “value.” For every option, there may be an implied default value that is assumed if it is not explicitly negotiated. The capture board 108 may reject any unsupported option based on the option tag by sending a negative response. If the capture board 108 is capable of supporting the value, it may respond with an affirmative response and takes effect on the next packet it sends.

If the capture board 108 may support a higher level, but not as high as the value specified by the mobile device 105, then the capture board 108 responds with an affirmative response packet having the tag and value that the capture board 108 actually supports (step 1022). For example, if the mobile device 105 requests a protocol level of “5” and the capture board 108 only supports a level of “2”, then the capture board 108 responds indicating it only supports a level of “2”. The mobile device 105 then set its protocol level to “2”. There may be a number of different protocol levels from Level 1 (step 1024) to Level Z (step 1026). Once the protocol level has been selected, the dedicated application and the capture board 108 adjust and optimize their operation for that protocol as further discussed with reference to FIG. 10B.

In the present embodiment, two protocol levels are available and are referred to as the basic protocol and Level 1 protocol accordingly. The basic protocol may be used with a capture board 108 having no display 318 or communication capabilities to the Internet 150. In some embodiments, this basic type of capture board 108 may only communicate with a single mobile device 105. Sessions using the basic protocol may have only one capture board 108. The Level 1 protocol may be used with one or more capture boards 108 that have a display 318 and/or communication capabilities to the Internet 150. The mobile device 105 notifies other devices 105 and/or 108 in the session of their respective capture boards 108 using one or more messages that provide a globally unique identifier for the board (which may be one or more 128-bit universally unique identifiers or another identifier of suitable bit length and uniqueness characteristics such as board size, capabilities, serial number, etc.) as described further below. This identifier may be used in subsequent communications to relay the packets to the correct device 105 and/or 108.

The protocol upgrade message may alter how the clocks of each of the devices 105 and/or 108 in the session are synchronized (step 1030). The basic protocol may not have clock synchronization as this level of capture board 108 does not produce absolute timestamps that are compared to an external reference clock. The clock is merely used as a reference for sorting messages properly. Conversely for Level 1, mobile devices 105 and capture boards 108 perform a Network Time Protocol (NTP) synchronization by way of a clock synchronization message. Each of the devices 105 and 108 determines a stratum (step 1032). The stratum may be measured based in part on the network distance of the particular device 105 and/or 108 to the time server. Each device 105 and/or 108 reports their stratum to the other devices 105 and/or 108 and receives the stratum of the other devices 105 and/or 108 (step 1034). The device 105 and/or 108 with the lower stratum may be designated as the master clock for synchronization purposes (step 1036). For example, a capture board 108 may have a stratum of 4 whereas the mobile devices 105 may have a stratum of 5, the capture board 108 will be selected as the master clock. If a device 105 and/or 108 is unable to access the time server, it is automatically assigned a stratum of 15 (or other high stratum value). If two devices 105 and/or 108 have the same stratum, the device 105 and/or 108 who initiated the session will be assumed to be the lower stratum. Alternatively, the stratum information may be recorded over time and the device 105 and/or 108 with the more reliable stratum level may be chosen. Once the master clock has been selected, the processing structure of each of the devices 105 and/or 108 synchronize their clocks with the master clock in a hierarchical fashion (e.g. stratum 2 synchronizes with stratum 1; stratum 3 synchronizes with stratum 2; etc). The processing structure then proceeds to increment the clock at the appropriate time interval.

With the basic protocol, the capture board 108 may transmit user-generated content that originates only by user interaction on the touch area 202. As a result, the basic protocol does not require a sophisticated method of differentiation of the source of annotations. In the case where the capture board 108 is multi-write capable, the only differentiation required may be a simple 8-bit contact number field that could be uniquely and solely determined by the capture board 108.

Level 1 protocol permits two-way user content generation where the communication may be concurrently transmitted between arbitrary numbers of the capture board(s) 108 and the mobile devices 105 each having one or more inking sources (step 1038). In order to identify which messages are from which device, all devices 105 and/or 108 have a globally unique identifier that in this example persists across all sessions ever created. In the case of a capture board 108, this is its serial number. In the case of the dedicated software application executing on the mobile device 105 an appropriately generated identifier e.g., a UUID. A serial number may not be a string of zero bits or a string of one bits. When a basic level capture board 108 attempts to connect to the two-way user content session, the mobile device 105 generates a unique ID for the basic level capture board 108 and acts as a proxy server that translates the basic level communications from the capture board 108 into a Level 1 communication protocol.

As transmitting every packet with a lengthy globally unique identifier adds significant overhead, a 16-bit alias may be chosen for the current session prior to transmitting any user-generated content packets. For remote, read-only participants in the session, no alias is required. The short address is based on a mechanism described in RFC 3927 Dynamic Configuration of IPv4 Link-Local Addresses, herein incorporated by reference. This address configuration is preferably performed immediately after clock synchronization.

Prior to the onset of address allocation, if the device 105 and/or 108 is not connected to any other devices 105 and/or 108, it may assign itself whatever address it chooses. Then, at the onset of address allocation, immediately following clock synchronization, the device 105 and/or 108 sends the other devices 105 and/or 108 an address allocation announcement specifying its global identifier and allocated address. The short address is determined by iterating the following procedure until successful.

The capture board 108 randomly picks a 16-bit address for itself that is different from any address used in a previous invocation of this step for this session (step 1040). It is recommended that the capture board 108 always begin by choosing the address ‘1’ or chosen by seeding a pseudorandom number generator with the device ID or MAC address of the capture board 108. The capture board 108 sends an address allocation request to the mobile device 105 (or other devices) and then preferably waits a minimum of 400 ms (step 1042). The notification payload indicates the global identifier of the capture board 108 and its desired short address.

The mobile device 105 maintains a table of known address allocations and consults it on receipt of the address allocation request. If the address selected by the capture board 108 was previously connected to the mobile device 105, the mobile device 105 responds affirmatively as the address is known previously to be unique. In response, the mobile device 105 gives the capture board 108 the most recently received announcement for the indicated address (step 1044). This announcement's payload includes the address that was allocated and the unique identifier (such as the serial number) of the capture board 108 to which it was allocated and two timestamps: the timestamp of the announcement itself and the time-of-first-announcement timestamp. Initially, these two timestamps may be the same but over time the timestamps will drift apart as further timestamp announcements are transmitted. If the mobile device 105 has knowledge of all allocated capture board 108 addresses in the session, the mobile device 105 allocates an address for the capture board 108, synthesizing an announcement for the capture board 108 on its behalf, and send that announcement to the session participants.

If the mobile device 105 does not have knowledge of all allocated capture board 108 addresses, then the mobile device 105 may forward the address allocation notification of the capture board 108 to other participants in the session such as other mobile devices 105 or capture boards 108 (step 1048). In the event of a conflict, the other participate device with the conflict will respond indicating there is a conflict. The mobile device 105 may then respond by generating a new address allocation notification. Preferably, all participant devices may maintain a list of known address allocations in the session so that the participant device may efficiently respond to address allocation notifications. Alternatively, each mobile device 105 in a session may pre-allocate a block of address aliases for use by capture boards 108 and mobile devices 105 connecting thereto.

If the capture board 108 receives a confirming address allocation response notification (e.g., one with acknowledging the global identifier of the capture board 108) within the 400 ms waiting period (step 1046), then the capture board 108 uses the short address specified in the original address allocation request. If the capture board 108 receives a conflicting address allocation response (e.g., one with the desired short address but a different global identifier) within the 400 ms waiting period (step 1046), then the capture board 108 aborts and attempts using a different short address repeating steps 1040 to 1046 until success or timeout (not shown). When resolving the conflict, one announcement may be taken as more authoritative than the other. For example, the announcement that has the lower (earlier) time-of-first-announcement timestamp successfully registers the global identifier to the short address. If two announcements have equal time-of-first-announcement timestamps, then the announcement with the “lower” global identifier (e.g. when treated as an unsigned number) successfully registers the global identifier to the short address.

The remaining capture boards 108 may claim ownership by sending address allocation notifications with chosen short address and global identifiers. On receipt of these notifications, the mobile device 105 verifies that the short address is not already allocated to a different capture board 108. If the short address has not already been allocated to a different capture board 108, the mobile device 105 caches the notification and forward it on to other mobile devices 105 (step 1048). If the mobile device 105 is already claimed by another capture board 108, the mobile device 105 responds by sending back the prior announcement stored in cache for the other capture board 108. The mobile device 105 may also forward the address allocation notification to the other mobile devices 105. Periodically, the mobile device 105 may expunge from cache any announcements with a timestamp older than, in this embodiment, about 30 minutes or other appropriate time frame.

During the 400 ms waiting period, the capture board 108 responds to any request or address allocation notifications for its proposed short address. If a conflicting announcement is received during this waiting period, the capture board 108 fails to register the short address and repeats the procedure with a different short address. If sixteen invocations of this procedure consecutively fail, the capture board 108 aborts the connection. If during the waiting period, the capture board 108 does not receive a conflicting announcement, the capture board 108 successfully registers ownership of the short address.

Periodically, the capture board 108 resends the address allocation notification to maintain ownership of the short address. One each subsequent address allocation notification, the timestamp is updated to reflect the current time but the time-of-first-announcement remains the same. In this embodiment, the address allocation notifications are made between 3 and 24 minutes although other time periods are possible.

Once a capture board 108 or mobile device 105 registers a short address, it may optionally send notifications that further describe the capabilities of the device or information about the user of the device. In this embodiment, a sequence of peer metadata messages, bounded by start and end messages, are used to transmit various characteristics of the capture board 108 or mobile device 105. This additional information may be used by other devices for attribution information, or to display contextual information.

Optionally, the device (either mobile device 105, capture board 108, or both) may deregister the short address by sending a address deallocation message. By transmitting this message, the device is able to remove its address information from the allocation caches in a faster manner than waiting for automatic deregistering after a timeout period such as 30 minutes. Once a device has deregistered its address, it must not use the address for any subsequent communications without first reregistering it.

The protocol upgrade message may alter how the mobile device 105 and the capture board 108 interpret the coordinate space and canvas size for the touch area 202 (step 1050). The resolution may be negotiated by reporting the number of bits of resolution for either the absolute coordinates, relative coordinates, or both, and the size of the touch area 202 (step 1052). The canvas size may then be scaled (step 1053). For example, in the basic protocol, tenths of a millimeter (0.1 mm) is expressed as either unsigned 16-bit integers in the case of absolute coordinates and dimensions or signed 12-bit integers in the case of relative coordinates. These mappings of coordinates corresponds to a maximum physical canvas size of approximately 6.5535 m (258″, or 21′ 6″) on an end or just over approximately 7.5191 m (296″, or 24′ 8″) on the diagonal for a 16:9 aspect ratio.

Alternatively, for the Level 1 protocol, a resolution of 5 μm (0.005 mm) is expressed as signed 24-bit integers for absolute coordinates, or signed 16-bit integers for relative coordinates. This increased resolution increases the amount of display space at a 1:1 zoom level available at the capture board. It also raises the maximum zoom-in scaling factor and minimum zoom-out scaling factor for a capture board 108 of a given size and display pixel density. Regardless of protocol level, the x-coordinate values increase in a rightward direction and y-coordinate values increase in a downward direction. For the capture board 108 without a display 318, the upper-left corner of the board is coordinate (0,0). For the capture board 108 with a display 318, (0,0) represents the center of the entire digital canvas and on startup, the board positions itself so that (0,0) is in the upper-left corner of the display.

The protocol upgrade message may also adjust a canvas size used in the session. For the basic protocol, the mapping of the capture board 108 size to the digital representation (e.g. canvas size) of the capture board 108 stored in memory 306 is 1:1 and no other content but the annotations drawn thereon are stored. The basic protocol only comprises the current snapshot and does not permit display of prior snapshots.

The Level 1 protocol permits capture boards 108 with displays 318 and thus may have a canvas larger than the physical display 318. The processor 302 of the capture board 108 may scale the view of the canvas larger or smaller. This scaling may be initiated when the FPGA 302 determines that a particular gesture have been executed within the touch area 202. The user may also browse past snapshots and alter content objects thereon. The Level 1 protocol may also permit different devices to keep what each shows on their display synchronized with one another by transmitting messages that describe their viewport by way of providing the unique identifier of the snapshots being displayed and the (x, y, width, height) tuple that describes a rectangular portions thereof presently being viewed.

The protocol upgrade message may alter how the digital ink is encoded (step 1054). A digital ink selection message is sent to the session participants and comprises the number of bits resolution and the corresponding width of the ink for one bit of resolution (step 1056). Other participants transmit a digital ink selection message in response. The lowest resolution common between all the of the devices 105 and/or 108 in the session is selected as the resolution of the digital ink (step 1057). For example, the basic protocol encodes an inking stroke as an unsigned 5-bit quantity, where one bit corresponds to approximately 0.5 mm of the nib of the pointer 204. For example, a standard pointer nib of 2.0 mm may be encoded as 0x04. In this embodiment, the Level 1 protocol also encodes the inking stroke in a similar manner; however, the inventor contemplates that different precision may be necessary with different pointer types.

The protocol upgrade message may also alter the base time reference (step 1058). For example, in the basic protocol, all timestamps are in Java time format: integer whole milliseconds since 1970-01-01T00:00:00.000Z, as unsigned 64-bit integer. In the Level 1 protocol, timestamps remain in integer whole milliseconds, but the reference time may be moved to 2015-01-01T00:00:00.000Z encoded as an unsigned 40-bit integer (step 1060). This permits future versions of the protocol to wrap at later dates. For example, the Level 1 protocol wraps on approximately 2049-11-03T19:53:47.775Z depending on the UTC adopting additional leap-seconds. In both the basic and Level 1 protocols, relative times are also in integer whole milliseconds and may be encoded as unsigned 16-bit integers restricting relative times to no more than 65.536 seconds.

The protocol upgrade message may also alter acceptable pointer 204 for use with the capture board 108 (step 1062). When devices 105 and/or 108 in a session are using the basic protocol, the capture board 108 is limited to discriminating between pointers 204 and erasers 206 only. This allows the session to only accept a binary or possibly grayscale page in instances where pressure or pointer width information is known. When devices 105 and/or 108 in a session are using a level 1 protocol, the capture board 108 may be able to discriminate between erasers, pens with colours such as black, red, green, and blue, and/or highlighter. The capture board 108 reports the pointer types, identifiers for the pointer types, and attributes thereof to the dedicated application on the mobile device 105 (step 1064). The inventor contemplates that other colours are possible and may be user selectable or chosen from an online profile. The capture board 108 may also be capable of identifying a cursor, such as the user's finger, which may be used to select and/or move graphical objects such as scrollbars, buttons, checkboxes, etc. As previously mentioned, the capture board 108 may determine the type of pointer 204 or eraser 206 based on the pointer size, modulated light, shape of pointer, glyph or iconography on the pointer, RF transmission, ultrasonic pulse, etc.

The protocol upgrade message may also alter the type of pointer 204 interactions with the capture board 108 to generate content objects that are available based, at least in part, on the capabilities of the mobile devices 105 and/or the capture board 108 connected to the session. Content objects may include annotations, alphanumeric text, images, video, active content, etc. A content object types message may be transmitted from the capture board 108 to the dedicated application executing on the mobile device 105 (step 1068). The content object types message contains all of the types of content objects recognized by the capture board 108. The dedicated application then identifies the content objects that it is also able to recognize and notifies the capture board 108 to only report these common content objects (step 1070). For example in the basic protocol, all user-generated content is limited to ink or annotations drawn on the capture board 108. When a user draws on the capture board 108 with a pointer 204, the stroke is detected and the recorded by the touch system as a path-related (or shape-related) message, such as a line path, shape path, or a curve path, within a STROKE_BEGIN/STROKE_END tags. The path-related message comprises a relative time stamp of the beginning of the stroke, stroke width, and (x,y) coordinates. For specific types of shapes, such as for example a circle, the shape related message (such as, for example, LINE_PATH, CURVE_PATH, CIRCLE_SHAPE, ELLIPSE_SHAPE, etc.) may be abbreviated as the (x,y) coordinates of the center of the circle and the radius. The inventor contemplates that other shapes may be represented using conic mathematical descriptions, cubic Bezier splines (or other type of spline), integrals (e.g. for filling in shapes), line segments, polygons, ellipses, etc. Alternatively the shapes may be represented by xml descriptions of scalable vector graphics (SVG). This path-related message is transmitted to the mobile device 105 which scales the stroke to the display size and displays the stroke in the specified location.

The basic protocol may also support multiple pointers 204 annotating on the same capture board 108 by appending an 8-bit contact number to the ink-related messages. When multiple pointers 204 are used, each pointer 204 may be assigned a pointer identifier that may be included in the path-related messages.

The Level 1 protocol permits, in this example, playing back the content objects of a session (step 1072). The capture device 108 reports to the session participant devices 105 and/or 108 that playback of content objects is permitted (step 1074) and a playback flag is set (step 1076) that causes the recording of the ending time for the content object to be stored in the content object. Alternatively, the relative time may be recorded for each location during the creation of the content object, or the relative time may be recorded at pauses during the creation of the content object (e.g. such as after drawing each segment of a shape). This time information may be used to interleave concurrent content objects and/or erasing content object (or portions thereof) on the capture board 108 by multiple pointers 204 by multiple users. In order to properly render the multiple content objects where the content objects may overlap, the content objects are sorted based on the creation timestamp. If the timestamp is identical for two or more content objects, then the unique address for the content object is used. When one of the devices 105 and/or 108 receives content objects from other devices 105 and/or 108 in the session, the content objects are rendered from the earliest creation timestamp to the most recent timestamp. When a content object is deleted, the status of the content object may be set to “deleted” resulting in the object not being rendered for presentation on the display 318 and/or 512. By deleting objects in this manner, the deletion may be undone in the future possibly from a “deleted content objects” list.

The protocol upgrade message may also alter how the snapshots are interpreted by the session. In the basic protocol, the stroke and pointer identification information for the annotations may be discarded and the page may be saved as a bitmap or vector graphics image. The dedicated application on the mobile device 105 maintains all previous snapshots.

If playback of the session is permitted, the Level 1 protocol snapshots retain much of the information received about the content objects and the session may then be played back at a later date using the relative time information for each content object. The capture board 108 may have additional memory 306 in order to save this additional snapshot information. If a content object is placed on the capture board 108 prior to synchronization of the clock, relative time information may be adjusted appropriately. Any device 105 and/or 108 participating in the session may take a snapshot. Alternatively, read-only participants may be prohibited from taking a snapshot. When a snapshot is taken, a snapshot message is transmitted to the devices 105 and/or 108 of the participants to inform those devices 105 and/or 108 to also take a snapshot. By taking the snapshots in this manner, network bandwidth usage may be reduced.

Alternatively or additionally, the content objects on the snapshot may be modified after the snapshot has been recorded. The capture board 108 may add additional content objects to the snapshot by sending an annotation begin message with a payload indicating the type of content object, unique identifier, and other properties such as the primary content stream. The primary content stream may not exist and may be supplied using an annotation metadata message that further describes attributes the content object. The content stream may then be transferred by sending one or more stream data messages bracketed between a stream begin and a stream end notification.

Devices 105 and/or 108 capable of the Level 1 protocol may uniquely identify each content object and snapshot by assigning a globally unique identifier such as a 128-bit UUID specified in IETF RFC 4122, herein incorporated by reference, as well as a 64-bit locally unique identifier. The globally unique identifier may comprise the device ID, which was previously determined to be unique for each device 105 and/or 108, and the locally unique identifier. The locally unique identifiers may be used by the device 105 and/or 108 to manage the annotations.

The protocol update message may also adjust the session in order to permit content objects from more than one device 105 and/or 108 (step 1078). In the basic protocol, only a single capture board 108 is permitted in the session and as such multi-directional inking is not possible. Further, the capture board 108 does not have a display 318 and therefore the session may not become a Level 1 protocol session. In the Level 1 session, the dedicated application on the primary mobile device 105 (e.g. the first mobile device 105 to connect to the capture board 108) receives content object messages from remotely connected capture boards 108 and/or mobile devices 105. The mobile device 105 relays these content object messages to the capture board 108 where the capture board 108 has previously initialized a content object service (step 1080) to receive these external content objects. The content object service orders and processes external content objects in a similar manner as content object messages generated locally. Alternatively, the capture board 108 may have a connection to the Internet 150 and may receive the remote content object messages directly rather than receive them via the mobile device 105.

Should the capture board 108 lose connection to the session or should the capture board 108 connect to an existing session, the mobile device 108 may initiate a synchronization by issuing a sync begin request. The sync begin request triggers the capture board 108 to discard the content objects recorded within its memory 306. The dedicated application then transmits one or more synchronization messages to the capture board. The synchronization messages contain session data comprising all content object and snapshot messages. The synchronization may be conducted in a block-based fashion whereby the session data may be bundled and transmitted in an efficient manner such as for example compressing and packaging several small messages into a larger message to reduce packet overhead. Alternatively, the synchronization may involve transmitting messages in a similar manner to how the messages were originally transmitted. Alternatively, the capture board 108 may indicate to the mobile device 105 the time the connection was lost and the mobile device 105 may synchronize the capture board 108 with session data after the connection lost time (or alternatively a predetermined time earlier than the connection lost time).

The protocol update message may also adjust ability for a device 105 and/or 108 to contribute content objects to the session. The basic protocol permits only a single source of content objects and all remote viewers are inherently read-only. For the Level 1 protocol, multidirectional generation of content objects is possible and therefore, certain devices 105 and/or 108 may be restricted from contributing content objects. The session originating device 105 may have the authority to restrict other devices from generating content object messages and/or to take snapshots. For example, a set of access levels may be present such as observer, participant, contributor, presenter, and/or organizer. The access levels have different rights associated with them. Observers can read all content but have no right to presence or identity (e.g. the observer device is anonymous). Participant devices may also read all content but the participant device also has the right to declare their presence and identity which implies participation in some activities within the conversation such as chat, polling, etc. by way of proxy but cannot directly contribute new user generated content. Contributor devices have general read/write access but cannot alter the access level of any other session device or terminate the session. Presenter devices have read/write access and can raise any participant to a contributor device and demote any contributor device to a participant device. Presenter devices cannot alter the access of other presenter or organizer devices and cannot terminate the session. Organizer devices have full read/write access to all aspects of the session, including altering other device access and terminating the conversation.

Each access level may be protected by one or more security options (e.g. a password-based hash or a PKI certificate) and the session originating device 105 may, as part of the establishment process, set at least the security options that gate access at the organizer level. For all other devices 105, at the time of joining an existing conversation, the devices 105 specify the level at which they will join and complete an authentication step applicable to the level at which the device 105 wishes to join.

As mentioned previously, some capture boards 108 may only communicate with a single mobile device 105 at a time under the basic protocol. When another mobile device 105 attempts a connection to the capture board 108, the connection is refused. Alternatively, the capture board 108 may disconnect from the originally connected mobile device 105 and switch to the new mobile device 105 that is attempted to connect.

If the protocol is raised to Level 1, the session is shared over the web via a session redirect message. The session redirect message comprises a hyperlink that other mobile devices 105 or external web connected clients (such as executing on a computer remotely) can access the session remotely via a web connection (e.g. wired, wireless, etc). The session redirect message may be similar to the pairing URL in that the session ID may be included to facilitate ease of connection. When another mobile device 105 attempts to connect to the capture board 108 with a mobile device 105 already connected, the capture board 108 transmits a session redirect message. The dedicated application then opens a two-way content generation session via the web address.

Although a Bluetooth connection is described herein, the inventor contemplates that other communication systems and standards may be used such as for example, IPv4/IPv6, Wi-Fi Direct, USB (in particular, HID), Apple's iAP, RS-232 serial, etc. In those systems, another uniquely identifiable address may be used to generate a board ID using a similar manner as described herein.

Although the embodiments described herein refer to a pen, the inventor contemplates that the pointer may be any type of pointing device such as a dry erase marker, ballpoint pen, ruler, pencil, finger, thumb, or any other generally elongate member. Preferably, these pen-type devices have one or more ends configured of a material as to not damage the display 318 or touch area 202 when coming into contact therewith under in-use forces.

Although the embodiments described herein state that the packets are fixed-length 100-byte packets, the inventor contemplates that different packet lengths are possible such as 20 bytes (16-byte payload), 36 bytes (32-byte payload), 52 bytes (48-byte payload), 100 bytes (96 byte payload), 116 bytes (112-byte payload), 132 bytes (128-byte payload) or may be larger than 128 bytes. The length of the packets may preferably be multiples of 16 bytes for AES 128-bit encryption to operate in Cipher Block Chaining (CBC) mode without padding. In another alternative embodiment, the packet length may be negotiated between the two communicating devices. In yet another alternative embodiment, Galois/Counter Mode (GCM) which may allow arbitrarily long packets which in this example may be limited to 8 KiB.

In an alternative embodiment, the control bar 210 may comprise an email icon. If one or more email addresses has been provided to the application executing on the mobile device 105, the FPGA 302 illuminates the email icon. When the pointer 204 contacts the email icon, the FPGA 302 pushes pending annotations to the mobile device 105 and reports to the processor of the mobile device 105 that the pages from the current notebook are to be transmitted to the email addresses. The processor then proceeds to transmit either a PDF file or a link to a location to a server on the Internet to the PDF file. If no designated email address is stored by the mobile device 105 and the pointer 204 contacts the email icon, a prompt to the user may be displayed on the display 318 whereby the user may enter email addresses through text recognition of writing events input via pointer 204. In this embodiment, input of the character “@” prompts the FPGA 302 to recognize input writing events as a designated email address.

The emitters and detectors may be narrower or wider, narrower angle or wider angle, various wavelengths, various powers, coherent or not, etc. As another example, different types of multiplexing may be used to allow light from multiple emitters to be received by each detector. In another alternative, the FPGA 302 may modulate the light emitted by the emitters to enable multiple emitters to be active at once.

The touch screen 306 can be any type of touch technology such as analog resistive, capacitive, projected capacitive, ultrasonic, infrared grid, camera-based (across touch surface, at the touch surface, away from the display, etc), in-cell optical, in-cell capacitive, in-cell resistive, electromagnetic, time-of-flight, frustrated total internal reflection (FTIR), diffused surface illumination, surface acoustic wave, bending wave touch, acoustic pulse recognition, force-sensing touch technology, or any other touch technology known in the art. The touch screen 306 could be a single touch, a multi-touch screen, or a multi-user, multi-touch screen.

Although the mobile device 200 is described as a smartphone 102, tablet 104, or laptop 106, in alternative embodiments, the mobile device 105 may be built into a conventional pen, a card-like device similar to an RFID card, a camera, or other portable device.

Although the servers 120, 122, 124 are described herein as discrete servers, other combinations may be possible. For example, the three servers may be incorporated into a single server, or there may be a plurality of each type of server in order to balance the server load.

These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; 7,274,356; and 7,532,206 assigned to SMART Technologies ULC of Calgary, Alberta, Canada, assignee of the subject application, the entire disclosures of which are incorporated by reference; touch systems comprising touch panels or tables employing electromagnetic, capacitive, acoustic or other technologies to register pointer input; laptop and tablet personal computers (PCs); smartphones, personal digital assistants (PDAs) and other handheld devices; and other similar devices.

Although the embodiment described herein have a 38-character pairing URL, the inventor contemplates that other lengths or pairing URLs may also be used.

Although the embodiments described herein pair using NFC or QR code, the inventor contemplates that other means of communication may be used for pairing and general communication between the devices, such as, but not limited to, WiFi, Bluetooth, WiFi Direct, LTE, 3G, wired Ethernet, Infrared, 1-dimensional bar code, etc.

Although the mapping of coordinates in the examples presented herein describe a maximum physical canvas size of approximately 6.5535 m (258″, or 21′ 6″) on an end or just over approximately 7.5191 m (296″, or 24′ 8″) on the diagonal for a 16:9 aspect ratio, the inventor contemplates that significantly larger canvas sizes are possible. For example, a resolution of 0.005 mm/bit with 24-bit signed storage results in a canvas size of approximately 42 meters. The inventor contemplates that other resolutions per bit are possible and other canvas sizes are possible. The inventor also contemplates that even though a higher resolution per bit may be used, the canvas size may be smaller than the maximum canvas size.

Although the examples described herein are in reference to a capture board 108, the inventor contemplates that the features and concepts may apply equally well to other collaborative devices 107 such as the interactive flat screen display 110, interactive whiteboard 112, the interactive table 114, or other type of interactive device. Each type of collaborative device 107 may have the same protocol level or different protocol levels.

The above-described embodiments are intended to be examples of the present invention and alterations and modifications may be effected thereto, by those of skill in the art, without departing from the scope of the invention, which is defined solely by the claims appended hereto.

What is claimed is:

1. A mobile device comprising:
a processing structure;
a transceiver communicating with a network using a communication protocol; and
a computer-readable medium comprising instructions to configure the processing structure to:
retrieve a pairing uniform resource locator (URL) from an interactive device;
convert the pairing URL into a network address;
establish a connection to the interactive device located at the network address using the transceiver;
query for device information of the interactive device over the connection;
authenticate the mobile device with the interactive device; and
receive at least one content object from the interactive device.

2. The mobile device according to claim 1 wherein the computer-readable medium further comprises instructions to configure the processing structure to initiate an optimization of the communication protocol.

3. The mobile device according to claim 2 wherein the optimization of the communication protocol comprises negotiation of a protocol level based in part on the device information.

4. The mobile device according to claim 3 wherein the protocol level comprises a set of protocol rules.

5. The mobile device according to claim 4 wherein at least one of the protocol rules comprises synchronizing a timer with a reference clock; the timer stored within the computer-readable medium and serviced by the processing structure.

6. The mobile device according to claim 4 wherein the computer-readable medium further comprises instructions to read a unique identifier for the mobile device.

7. The mobile device according to claim 6 wherein at least one of the protocol rules comprises negotiating an alias for the unique identifier.

8. The mobile device according to claim 4 wherein at least one of the protocol rules comprises adjusting a resolution of a coordinate space.

9. The mobile device according to claim 8 wherein the resolution comprises at least one of an absolute coordinate resolution, a relative coordinate resolution, or both the absolute and the relative coordinate resolution.

10. The mobile device according to claim 8 wherein the coordinate space corresponds to a canvas size comprising a diagonal of less than about 7.5191 m for a 16:9 aspect ratio.

11. The mobile device according to claim 9 wherein the absolute coordinate resolution is between about 0.005 mm/bit and about 0.1 mm/bit.

12. The mobile device according to claim 9 wherein the relative coordinate resolution is between about 0.005 mm/bit and about 0.1 mm/bit.

13. The mobile device according to claim 4 wherein the at least one content object comprises at least one of a digital ink object, a shape object, a curve object, a vector object, an audio object, an image object, a text object, or a video object.

14. The mobile device according to claim 13 wherein at least one of the protocol rules comprises adjusting at least one digital ink attribute of the digital ink object.

15. The mobile device according to claim 14 wherein the at least one digital ink attribute comprises a pointer resolution of 0.5 mm/bit.

16. The mobile device according to claim 14 wherein the at least one digital ink attribute comprises a stroke colour.

17. The mobile device according to claim 14 wherein the at least one digital ink attribute comprises a set of unique pointer identifiers.

18. The mobile device according to claim 5 wherein each content object has a unique content object identifier.

19. The mobile device according to claim 18 wherein each content object has a creation timestamp retrieved from the timer.

20. The mobile device according to claim 1 wherein the computer-readable medium further comprises instructions to configure the processing structure to receive remote content objects from remote interactive devices.

21. The mobile device according to claim 1 wherein the interactive device comprises at least one of a capture board, an interactive whiteboard, an interactive flat screen display, or an interactive table.

22. The mobile device according to claim 1 further comprising an image sensor to capture an optically recognizable image.

23. The mobile device according to claim 22 further comprising instructions to decode the optically recognizable image to retrieve the pairing uniform resource locator.

24. The mobile device according to claim 1 further comprising a near field radio frequency reader to receive the pairing URL.

25. A method of establishing a connection between a mobile device and an interactive device comprising:
retrieving a pairing uniform resource locator (URL) from the interactive device;
converting, using a processing structure, the pairing URL into a network address;
establishing the connection to the interactive device located at the network address using a transceiver;
querying for device information of the interactive device over the connection;
authenticating the mobile device with the interactive device; and
receiving at least one content object from the interactive device.

26. The method according to claim 25 further comprising initiating an optimization of a communication protocol by negotiating a protocol level based in part on the device information.

27. The method according to claim 26 further comprising altering a set of protocol rules based on the protocol level.

28. The method according to claim 27 wherein at least one of the protocol rules comprises synchronizing a timer with a reference clock.

29. The method according to claim 27 further comprising retrieving by the processing structure a unique identifier for the mobile device.

30. The method according to claim 27 further comprising adjusting a resolution of a coordinate space.

31. The method according to claim 30 wherein the resolution comprises at least one of an absolute coordinate resolution, a relative coordinate resolution, or both the absolute and the relative coordinate resolution.

32. The method according to claim 31 wherein the absolute coordinate resolution is between about 0.005 mm/bit and about 0.1 mm/bit.

33. The method according to claim 31 wherein the relative coordinate resolution is between about 0.005 mm/bit and about 0.1 mm/bit.

34. The method according to claim 25 wherein the at least one content object comprises at least one of digital ink object, a shape object, a curve object, a vector object, an audio object, an image object, a text object, or a video object.

35. The method according to claim 34 further comprising adjusting at least one digital ink attribute of the digital ink object.

36. The method according to claim 35 wherein the at least one digital ink attribute comprises a stroke colour.

37. The method according to claim 35 wherein the at least one digital ink attribute comprises a set of unique pointer identifiers.

38. The method according to claim 28 further comprising assigning at least a portion of the content objects with a unique content object identifier.

39. The method according to claim 38 further comprising appending at least a portion of the content object with a creation timestamp retrieved from the timer.

40. The method according to claim 39 further comprising displaying content objects with creation timestamps on a display at a relative time according to their respective creation timestamp.

41. The method according to claim 27 further comprising receiving remote content objects from remote interactive devices.

42. The method according to claim 25 wherein the interactive device comprises at least one of a capture board, an interactive whiteboard, an interactive flat screen display, or an interactive table.

43. The method according to claim 25 further comprising optically recognizing a captured image from an image sensor.

44. The method according to claim 43 further comprising decoding the captured image to retrieve the pairing uniform resource locator.

45. The method according to claim 25 further comprising reading a near field radio frequency tag to receive the pairing URL.

46. An interactive device comprising:
a processing structure;
an interactive surface;
a transceiver communicating with a network using a communication protocol; and
a computer-readable medium comprising instructions to configure the processing structure to:
provide a service to receive connections from a mobile device;
respond to a query for device information over at least one of the connections;
authenticate the mobile device with the interactive device; and
transmit at least one content object over at least one of the connections to the mobile device.

47. The interactive device according to claim 46 wherein the computer-readable medium comprises instructions to configure the processing structure to optimize the communication protocol by negotiating a protocol level.

48. The interactive device according to claim 47 wherein the protocol level comprises a set of protocol rules.

49. The interactive device according to claim 48 wherein at least one of the protocol rules comprises synchronizing a local timer with a timer of the mobile device; the local timer stored within the computer-readable medium and serviced by the processing structure.

50. The interactive device according to claim 46 wherein the computer-readable medium further comprises a unique identifier for the interactive device.

51. The interactive device according to claim 48 wherein at least one of the protocol rules comprises adjusting a resolution of a coordinate space.

52. The interactive device according to claim 51 wherein the resolution comprises at least one of an absolute coordinate resolution, a relative coordinate resolution, or both the absolute and the relative coordinate resolution.

53. The interactive device according to claim 51 wherein the coordinate space corresponds to a canvas size comprising a diagonal of less than about 7.5191 m for a 16:9 aspect ratio.

54. The interactive device according to claim 52 wherein the absolute coordinate resolution is between about 0.005 mm/bit and about 0.1 mm/bit.

55. The interactive device according to claim 52 wherein the relative coordinate resolution is between about 0.005 mm/bit and about 0.1 mm/bit.

56. The interactive device according to claim 46 wherein the at least one content object comprises at least one of a digital ink object, a shape object, a curve object, a vector object, an audio object, an image object, a text object, or a video object.

57. The interactive device according to claim 56 wherein at least one of the protocol rules comprises adjusting at least one digital ink attribute of the digital ink object.

58. The interactive device according to claim 57 wherein the at least one digital ink attribute comprises a pointer resolution of 0.5 mm/bit.

59. The interactive device according to claim 57 wherein the at least one digital ink attribute comprises a stroke colour.

60. The interactive device according to claim 57 wherein the at least one digital ink attribute comprises a set of unique pointer identifiers.

61. The interactive device according to claim 49 wherein at least one of the content object has a unique content object identifier.

62. The interactive device according to claim 61 wherein at least one of the content object has a creation timestamp retrieved from the timer.

63. The interactive device according to claim 62 wherein the computer-readable medium further comprises instructions to configure the processing structure to display content objects with creation timestamps at a relative time according to their respective creation timestamp.

64. The interactive device according to claim 46 wherein the computer-readable medium further comprises instructions to configure the processing structure to receive remote content objects from remote interactive devices.

65. The interactive device according to claim 46 wherein the interactive device comprises at least one of a capture board, an interactive whiteboard, an interactive flat screen display, or an interactive table.
